(19) United States
(12) Patent Application Publication
(10) Pub. No.: US 2026/0063873 A1
(43) Pub. Date: Mar. 5, 2026

(54) IMAGING OPTICAL SYSTEM

(71) Applicant: NIDEC INSTRUMENTS CORPORATION, Nagano (JP)

(72) Inventor: Takuya KASAHARA, Nagano (JP)

(21) Appl. No.: 19/312,302

(22) Filed: Aug. 28, 2025

(30) Foreign Application Priority Data
Aug. 30, 2024 (JP) 2024-148360

(51) Int. Cl. G02B 13/00; G02B 9/64

(52) U.S. Cl. CPC G02B 13/0045; G02B 9/64

(57) ABSTRACT

An imaging optical system includes: in order from an object side to an image side, a front group; a diaphragm; and a rear group. The front group includes a plurality of lenses including a first lens arranged closest to the object side. The rear group includes a plurality of lenses. The first lens has a negative power. When a total track of an entire lens system is d0, an effective radius of a lens surface of the first lens on the object side is sd11, and a maximum image height is IH, the following conditional expressions:

$$3. < d 0 / sd 11 < 4.5 \qquad ( 1 )$$

$$2.5 < d 0 / IH < 5. 000 \qquad ( 2 )$$

are satisfied.

### CROSS REFERENCE TO RELATED APPLICATION

The present invention claims priority under 35 U.S. C. § 119 to Japanese Application No. 2024-148360 filed Aug. 30, 2024, the entire content of which is incorporated herein by reference.

### BACKGROUND

### Field of the Invention

At least an embodiment of the present invention relates to an imaging optical system.

An imaging optical system used for an in-vehicle camera or a surveillance camera is described in Japanese Unexamined Patent Application Publication No. 2022-112893.

The imaging optical system in JP-A No. 2022-112893 includes an aperture diaphragm, a first lens group arranged closer to an object side than the aperture diaphragm, and a second lens group arranged closer to an image side than the aperture diaphragm. Each of the first lens group and the second lens group includes a plurality of lenses. The first lens group includes a first lens arranged closest to the object side, and the first lens is exposed from a lens barrel or the like that covers the imaging optical system.

### Description of the Related Documents

In an imaging optical system used for an in-vehicle camera or a surveillance camera, a first lens is required to be downsized from the viewpoint of design and from the viewpoint of preventing a user from feeling that he/she is monitored by the imaging optical system. However, in the imaging optical system in JP-A No. 2022-112893, it is difficult to downsize the first lens while suppressing a decrease in optical characteristics.

In view of the above-described problem, it is an object of at least an embodiment of the present invention to provide an imaging optical system capable of downsizing a first lens while suppressing a decrease in optical characteristics.

### SUMMARY

In order to solve the above-described object, an imaging optical system of at least an embodiment of the present invention includes: in order from an object side to an image side, a front group; a diaphragm; and a rear group, in which the front group includes a plurality of lenses including a first lens arranged closest to the object side, the rear group includes a plurality of lenses, the first lens has a negative power, and, when a total track of an entire lens system is d0, an effective radius of a lens surface of the first lens on the object side is sd11, and a maximum image height is IH, the following conditional expressions are satisfied:

$$3. < d 0 / sd 11 < 4.5 ; \qquad ( 1 )$$

$$2.5 < d 0 / IH < 5. 0. \qquad ( 2 )$$

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is an explanatory diagram of an imaging optical system according to a first embodiment;

FIG. 2 is a diagram showing data of the imaging optical system of the first embodiment;

FIG. 3 is a diagram showing spherical aberration of the imaging optical system illustrated in FIG. 1;

FIG. 4 is a diagram showing chromatic aberration of magnification of the imaging optical system illustrated in FIG. 1;

FIG. 5 is a diagram showing astigmatic aberration and distortion of the imaging optical system illustrated in FIG. 1;

FIG. 6 is a diagram showing transverse aberration of the imaging optical system illustrated in FIG. 1;

FIG. 7 is an explanatory diagram of an imaging optical system according to a second embodiment;

FIG. 8 is a diagram showing data of the imaging optical system of the second embodiment;

FIG. 9 is a diagram showing spherical aberration of the imaging optical system illustrated in FIG. 7;

FIG. 10 is a diagram showing chromatic aberration of magnification of the imaging optical system illustrated in FIG. 7;

FIG. 11 is a diagram showing astigmatic aberration and distortion of the imaging optical system illustrated in FIG. 7;

FIG. 12 is a diagram showing transverse aberration of the imaging optical system illustrated in FIG. 7;

FIG. 13 is an explanatory diagram of an imaging optical system according to a third embodiment;

FIG. 14 is a diagram showing data of the imaging optical system of the third embodiment;

FIG. 15 is a diagram showing spherical aberration of the imaging optical system illustrated in FIG. 13;

FIG. 16 is a diagram showing chromatic aberration of magnification of the imaging optical system illustrated in FIG. 13;

FIG. 17 is a diagram showing astigmatic aberration and distortion of the imaging optical system illustrated in FIG. 13;

FIG. 18 is a diagram showing transverse aberration of the imaging optical system illustrated in FIG. 13;

FIG. 19 is an explanatory diagram of an imaging optical system according to a fourth embodiment;

FIG. 20 is a diagram showing data of the imaging optical system of the fourth embodiment;

FIG. 21 is a diagram showing spherical aberration of the imaging optical system illustrated in FIG. 19;

FIG. 22 is a diagram showing chromatic aberration of magnification of the imaging optical system illustrated in FIG. 19;

FIG. 23 is a diagram showing astigmatic aberration and distortion of the imaging optical system illustrated in FIG. 19;

FIG. 24 is a diagram showing transverse aberration of the imaging optical system illustrated in FIG. 19;

FIG. 25 is an explanatory diagram of an imaging optical system according to a fifth embodiment;

FIG. 26 is a diagram showing data of the imaging optical system of the fifth embodiment;

FIG. 27 is a diagram showing spherical aberration of the imaging optical system illustrated in FIG. 25;

FIG. 28 is a diagram showing chromatic aberration of magnification of the imaging optical system illustrated in FIG. 25;

FIG. 29 is a diagram showing astigmatic aberration and distortion of the imaging optical system illustrated in FIG. 25;

FIG. 30 is a diagram showing transverse aberration of the imaging optical system illustrated in FIG. 25;

FIG. 31 is an explanatory diagram of an imaging optical system according to a sixth embodiment;

FIG. 32 is a diagram showing data of the imaging optical system of the sixth embodiment;

FIG. 33 is a diagram showing spherical aberration of the imaging optical system illustrated in FIG. 31;

FIG. 34 is a diagram showing chromatic aberration of magnification of the imaging optical system illustrated in FIG. 31;

FIG. 35 is a diagram showing astigmatic aberration and distortion of the imaging optical system illustrated in FIG. 31;

FIG. 36 is a diagram showing transverse aberration of the imaging optical system illustrated in FIG. 31;

FIG. 37 is an explanatory diagram of an imaging optical system according to a seventh embodiment;

FIG. 38 is a diagram showing data of the imaging optical system of the seventh embodiment;

FIG. 39 is a diagram showing spherical aberration of the imaging optical system illustrated in FIG. 37;

FIG. 40 is a diagram showing chromatic aberration of magnification of the imaging optical system illustrated in FIG. 37;

FIG. 41 is a diagram showing astigmatic aberration and distortion of the imaging optical system illustrated in FIG. 37; and

FIG. 42 is a diagram showing transverse aberration of the imaging optical system illustrated in FIG. 37.

### DETAILED DESCRIPTION

Hereinafter, embodiments of an imaging optical system 100 to which at least an embodiment of the present invention is applied will be described. The imaging optical system 100 is used for an in-vehicle camera or a surveillance camera. In particular, the imaging optical system 100 is suitable for use in a surveillance camera for monitoring the inside of a vehicle.

### First Embodiment

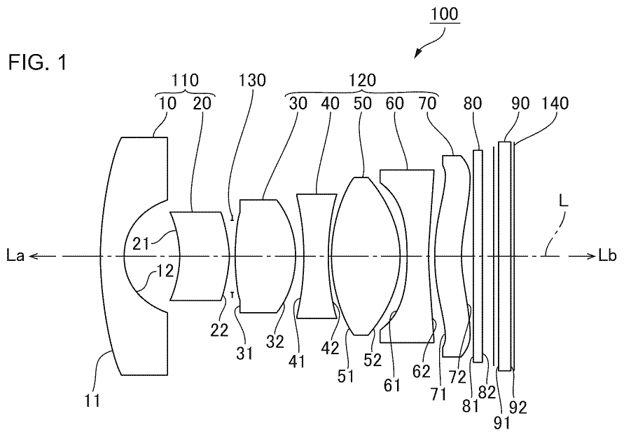

FIG. 1 is an explanatory diagram of the imaging optical system 100 according to a first embodiment. As illustrated in FIG. 1, the imaging optical system 100 of the present embodiment includes, in order from an object side La to an image side Lb, a front group 110, a diaphragm 130, a rear group 120, and an infrared cut filter 80.

The front group 110 includes, in order from the object side La to the image side Lb, a first lens 10 and a second lens 20. The rear group 120 includes, in order from the object side La to the image side Lb, a third lens 30, a fourth lens 40, a fifth lens 50, a sixth lens 60, and a seventh lens 70. On the image side Lb of the seventh lens 70, in order from the object side La to the image side Lb, the plate-like infrared cut filter 80, a translucent cover 90, and an imaging element 140 are arranged. The imaging element 140 is arranged on an imaging plane of the imaging optical system 100 on the image side Lb.

The first lens 10 is made of resin. The first lens 10 has a negative power. The first lens 10 has a convex shape on a lens surface 11 on the object side La, and has a concave shape on a lens surface 12 on the image side Lb. The first lens 10 has an aspherical shape on the lens surface 12.

The second lens 20 is made of resin. The second lens 20 has a negative power. The second lens 20 has a concave shape on a lens surface 21 on the object side La, and has a convex shape on a lens surface 22 on the image side Lb. The second lens 20 has an aspherical shape on both surfaces.

The third lens 30 is made of glass. The third lens 30 has a positive power. The third lens 30 has a convex shape on a lens surface 31 on the object side La, and has a convex shape on a lens surface 32 on the image side Lb.

The fourth lens 40 is made of resin. The fourth lens 40 has a negative power. The fourth lens 40 has a concave shape on a lens surface 41 on the object side La, and has a concave shape on a lens surface 42 on the image side Lb. The fourth lens 40 has an aspherical shape on both surfaces.

The fifth lens 50 is made of resin. The fifth lens 50 has a positive power. The fifth lens 50 has a convex shape on a lens surface 51 on the object side La, and has a convex shape on a lens surface 52 on the image side Lb. The fifth lens 50 has an aspherical shape on both surfaces.

The sixth lens 60 is made of resin. The sixth lens 60 has a negative power. The sixth lens 60 has a concave shape on a lens surface 61 on the object side La, and has a concave shape on a lens surface 62 on the image side Lb. The sixth lens 60 has an aspherical shape on both surfaces.

The seventh lens 70 is made of resin. The seventh lens 70 has a positive power. The seventh lens 70 has a convex shape on a lens surface 71 on the object side La, and has a concave shape on a lens surface 72 on the image side Lb. The seventh lens 70 has an aspherical shape on both surfaces.

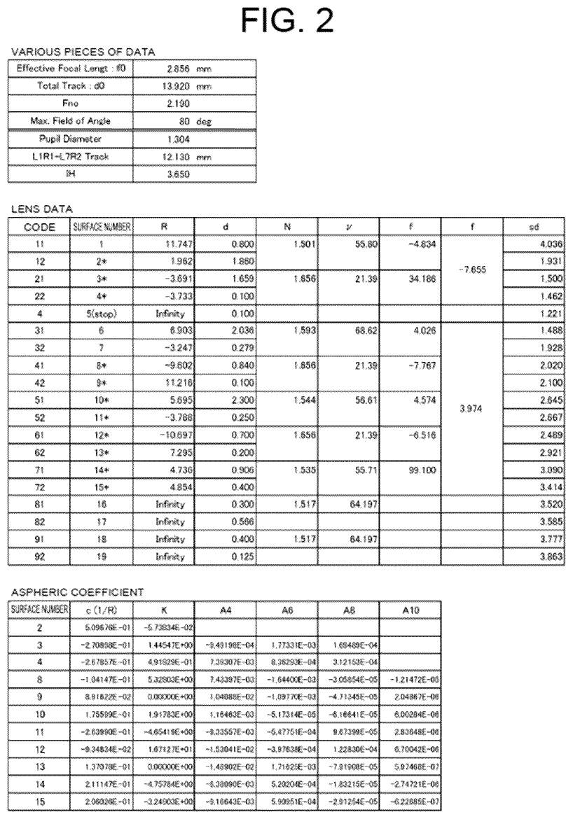

FIG. 2 is a diagram showing data of the imaging optical system 100 of the first embodiment. The values shown in FIG. 2 are rounded off.

FIG. 2 shows various pieces of data described below. Here, in the various pieces of data, the total track of the entire lens system is a distance on an optical axis L from the lens surface 11 of the first lens 10 on the object side La to the imaging plane of the imaging element 140. The total track between the first lens and the seventh lens is a distance on the optical axis L from the lens surface 11 of the first lens 10 on the object side La to the lens surface 72 of the seventh lens 70 on the image side Lb.
Focal Length of Entire Lens System f0 (Effective Focal Length)
Total Track of Entire Lens System d0 (Total Track)
F-number of Entire Lens System (Fno)
Maximum Half Field Angle (Max. Field Angle)
Pupil Diameter (Pupil Diameter)
Total Track Between First Lens and Seventh Lens (L1R1-L7R2 Track)

Moreover, FIG. 2 shows lens data of each lens described below. In the lens data, a surface denoted by a surface number with * is an aspherical surface. The curvature radius is denoted by R. The surface spacing is denoted by d. The refractive index is denoted by N. The Abbe number is denoted by v. The focal length is denoted by f. The effective radius is denoted by sd. The unit of the curvature radius, the surface spacing, and the focal length is mm. Furthermore, FIG. 2 shows an aspheric coefficient indicating the shape of the aspherical surface in each surface number.

In the imaging optical system 100, when the total track of the entire lens system is d0, the effective radius of the lens surface 11 of the first lens 10 on the object side is sd11, and the maximum image height is IH, the following conditional expressions:

$$3. < d 0 / sd 11 < 4.5 \qquad ( 1 )$$

$$2.5 < d 0 / IH < 5. 000 \qquad ( 2 )$$

are satisfied.

The following holds in the present embodiment.

$$d 0 = 13 \text{.920}$$

$$sd 11 = 4.036$$

$$IH = 3.65$$

Thus, d0/sd11=3.449 is obtained, and the conditional expression (1) is satisfied. Moreover, d0/IH=3.814 is obtained, and the conditional expression (2) is satisfied.

In the imaging optical system 100, when the effective radius of the lens surface 11 of the first lens 10 on the object side is sd11, and the maximum image height is IH, the following conditional expression:

$$0.65 < sd 11 / IH < 1 \text{.300} \qquad ( 3 )$$

is satisfied.

The following holds in the present embodiment.

$$sd 11 = 4.036$$

$$IH = 3.65$$

Thus, sd11/IH=1.106 is obtained, and the conditional expression (3) is satisfied.

In the imaging optical system 100, when the curvature radius of the lens surface 11 of the first lens 10 on the object side is R11, and the curvature radius of the lens surface 12 of the first lens 10 on the image side is R12, the following conditional expression:

$$1.1 < ( R 11 + R 12 ) / ( R 11 - R 12 ) < 2 \text{.000} \qquad ( 4 )$$

is satisfied.

The following holds in the present embodiment.

$$R 11 = 11.747$$

$$R 12 = 1.962$$

Thus, (R11+R12)/(R11−R12)=1.401 is obtained, and the conditional expression (4) is satisfied.

In the imaging optical system 100, when the focal length of the entire lens system is f0, and the curvature radius of the lens surface 11 of the first lens 10 on the object side is R11, the following conditional expression:

$$2. < R 11 / f 0 < 9 \text{.000} \qquad ( 5 )$$

is satisfied.

The following holds in the present embodiment.

$$f 0 = 2 \text{.856}$$

$$R 11 = 11.747$$

Thus, R11/f0=4.113 is obtained, and the conditional expression (5) is satisfied.

In the imaging optical system 100, when the focal length of the entire lens system is f0, and the curvature radius of the lens surface 12 of the first lens 10 on the image side is R12, the following conditional expression:

$$0.5 < R 12 / f 0 < 3 \text{.000} \qquad ( 6 )$$

is satisfied.

The following holds in the present embodiment.

$$f 0 = 2 \text{.856}$$

$$R 12 = 1.962$$

Thus, R12/f0=0.687 is obtained, and the conditional expression (6) is satisfied.

In the imaging optical system 100, when the focal length of the entire lens system is f0, the curvature radius of the lens surface 21 of the second lens 20 on the object side is R21, and the curvature radius of the lens surface 22 of the second lens 20 on the image side is R22, the following conditional expressions:

$$- 6.000 < R 21 / f 0 < - 1.5 \qquad ( 7 )$$

$$- 6. 00 < R 22 / f 0 < - 1.5 \qquad ( 8 )$$

are satisfied.

The following holds in the present embodiment.

$$f 0 = 2 \text{.856}$$

$$R 21 = - 3.6 \; 91$$

$$R 22 = - 3.733$$

Thus, R21/f0=−1.292 is obtained, and the conditional expression (7) is satisfied. Moreover, R22/f0=−1.307 is obtained, and the conditional expression (8) is satisfied.

In the imaging optical system 100, when the Abbe number of the fifth lens 50 is v5, and the Abbe number of the sixth lens 60 is v6, the following conditional expressions:

$$50. < v 5 \qquad ( 9 )$$

$$v 6 < 30.0 \; 00 \qquad ( 10 )$$

are satisfied.

The following holds in the present embodiment.

$$v 5 = 56 \text{.61}$$

$$v 6 = 21.39$$

Thus, the conditional expression (9) and the conditional expression (10) are satisfied.

In the imaging optical system 100, when the total track of the entire lens system is d0, and the focal length of the entire lens system is f0, the following conditional expression:

$$3.5 < d 0 / f 0 < 7 \text{.500} \qquad ( 11 )$$

is satisfied.

The following holds in the present embodiment.

$$d 0 = 13 \text{.920}$$

$$f 0 = 2.856$$

Thus, d0/f0=4.874 is obtained, and the conditional expression (11) is satisfied.

In the imaging optical system 100, when the maximum field angle is ω, the following conditional expression:

$$120 < ω < 180 \qquad ( 12 )$$

is satisfied.

The following holds in the present embodiment.

$$ω = 160$$

Thus, the conditional expression (12) is satisfied.

### Operation and Effect

Since the imaging optical system 100 of the present embodiment satisfies the conditional expression (1), the first lens 10 and the total track of the entire lens system are downsized. When the value of the conditional expression (1) is below the lower limit, the first lens 10 becomes large with respect to the total track of the entire lens system, and thus the imaging optical system 100 is upsized. When the value of the conditional expression (1) exceeds the upper limit, the first lens 10 becomes too small with respect to the total track of the entire lens system, and thus the peripheral brightness cannot be ensured, and the imaging optical system 100 becomes dark.

Since the imaging optical system 100 of the present embodiment satisfies the conditional expression (2), various types of aberration can be favorably corrected, and the total track of the entire lens system is downsized. When the value of the conditional expression (2) is below the lower limit, the angle of the light beam incident on the imaging element 140 becomes large, and various types of aberration cannot be favorably corrected. When the value of the conditional expression (2) exceeds the upper limit, various types of aberration can be favorably corrected, but the total track of the entire lens system is upsized.

Since the imaging optical system 100 of the present embodiment satisfies the conditional expression (3), the first lens 10 is downsized while maintaining the brightness of the imaging optical system 100. When the value of the conditional expression (3) is below the lower limit, the first lens 10 is downsized, but the first lens 10 becomes too small, and thus the peripheral brightness cannot be ensured, and the imaging optical system 100 becomes dark. When the value of the conditional expression (3) exceeds the upper limit, the imaging optical system 100 becomes bright as the first lens 10 becomes large, but the first lens 10 is upsized.

Since the imaging optical system 100 of the present embodiment satisfies the conditional expression (4), it becomes easy to form the first lens 10 while ensuring the negative power of the first lens 10. When the value of the conditional expression (4) is below the lower limit, the curvature radius of the lens surface 12 of the first lens 10 on the image side becomes too small with respect to the curvature radius of the lens surface 11 of the first lens 10 on the object side, and thus it becomes difficult to form the first lens 10. When the value of the conditional expression (4) exceeds the upper limit, it becomes easy to form the first lens 10, but it becomes difficult to sufficiently ensure the negative power of the first lens 10.

Since the imaging optical system 100 of the present embodiment satisfies the conditional expression (5), various types of aberration can be appropriately corrected while ensuring the negative power of the first lens 10. When the value of the conditional expression (5) is below the lower limit, the negative power of the first lens 10 can be ensured, but the curvature radius of the lens surface 11 of the first lens 10 on the object side becomes too small with respect to the negative power of the first lens 10, and thus various types of aberration cannot be appropriately corrected. In addition, since the curvature radius of the lens surface 11 of the first lens 10 on the object side becomes too small, it becomes difficult to form the first lens 10. When the value of the conditional expression (5) exceeds the upper limit, since the curvature radius of the lens surface 11 of the first lens 10 on the object side becomes large with respect to the negative power of the first lens 10, various types of aberration can be appropriately corrected, but it becomes difficult to sufficiently ensure the negative power of the first lens 10. As a result, the total track of the entire lens system tends to be large.

Since the imaging optical system 100 of the present embodiment satisfies the conditional expression (6), various types of aberration can be appropriately corrected while ensuring the negative power of the first lens 10. When the value of the conditional expression (6) is below the lower limit, the negative power of the first lens 10 can be ensured, but the curvature radius of the lens surface 12 of the first lens 10 on the image side becomes too small with respect to the negative power of the first lens 10, and thus various types of aberration cannot be appropriately corrected. In addition, since the curvature radius of the lens surface 12 of the first lens 10 on the image side becomes too small, it becomes difficult to form the first lens 10. When the value of the conditional expression (6) exceeds the upper limit, since the curvature radius of the lens surface 12 of the first lens 10 on the image side becomes large with respect to the negative power of the first lens 10, various types of aberration can be appropriately corrected, but it becomes difficult to sufficiently ensure the negative power of the first lens 10. As a result, the total track of the entire lens system tends to be large.

Since the imaging optical system 100 of the present embodiment satisfies the conditional expressions (7) and (8), various types of aberration can be appropriately corrected while ensuring the negative power of the second lens 20. When the value of the conditional expression (7) is below the lower limit, the negative power of the second lens 20 can be ensured, but the curvature radius of the lens surface 21 of the second lens 20 on the object side becomes too small with respect to the negative power of the second lens 20, and thus various types of aberration cannot be appropriately corrected. When the value of the conditional expression (8) is below the lower limit, the negative power of the second lens 20 can be ensured, but the curvature radius of the lens surface 22 of the second lens 20 on the image side becomes too small with respect to the negative power of the second lens 20, and thus various types of aberration cannot be appropriately corrected. In addition, since the curvature radii of the second lens 20 on both sides become too small, it becomes difficult to form the second lens 20. When the value of the conditional expression (7) exceeds the upper limit, since the curvature radius of the lens surface 21 of the second lens 20 on the object side becomes large with respect to the negative power of the second lens 20, various types of aberration can be appropriately corrected, but it becomes difficult to sufficiently ensure the negative power of the second lens 20. As a result, the total track of the entire lens system tends to be large. When the value of the conditional expression (8) exceeds the upper limit, since the curvature radius of the lens surface 22 of the second lens 20 on the image side becomes large with respect to the negative power of the second lens 20, various types of aberration can be appropriately corrected, but it becomes difficult to sufficiently ensure the negative power of the second lens 20. As a result, the total track of the entire lens system tends to be large.

Since the imaging optical system 100 of the present embodiment satisfies the conditional expressions (9) and (10), the chromatic aberration can be appropriately corrected.

Since the imaging optical system 100 of the present embodiment satisfies the conditional expression (11), an increase in the total track of the entire lens system can be suppressed, and the occurrence of various types of aberration can be suppressed.

When the value of the conditional expression (11) is below the lower limit value, it is difficult to suppress the occurrence of various types of aberration. When the value of the conditional expression (11) exceeds the upper limit value, each lens system tends to be large, and the total track of the entire lens system tends to be large.

Since the imaging optical system 100 of the present embodiment satisfies the conditional expression (12), a camera using the imaging optical system 100 can image a wide range, and can suppress a large decrease in the peripheral brightness with respect to the central brightness.

In the imaging optical system 100 of the present embodiment, the third lens 30 is made of glass, and the fifth lens 50 is made of resin. Accordingly, the temperature characteristics of the imaging optical system 100 are improved.

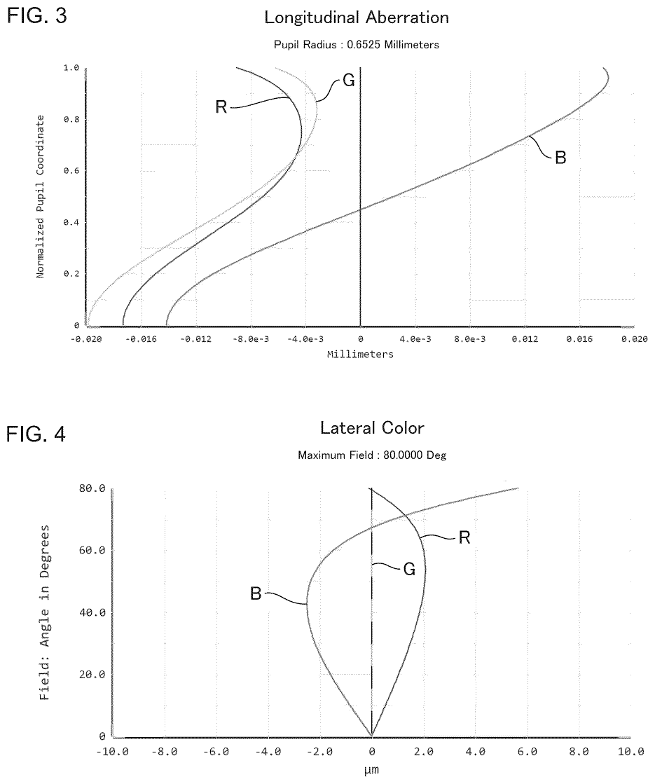

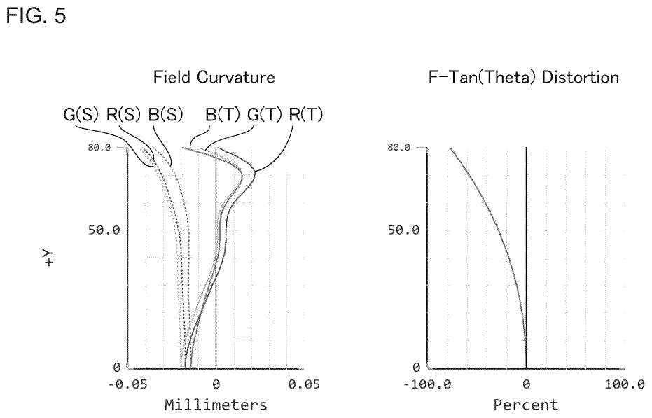

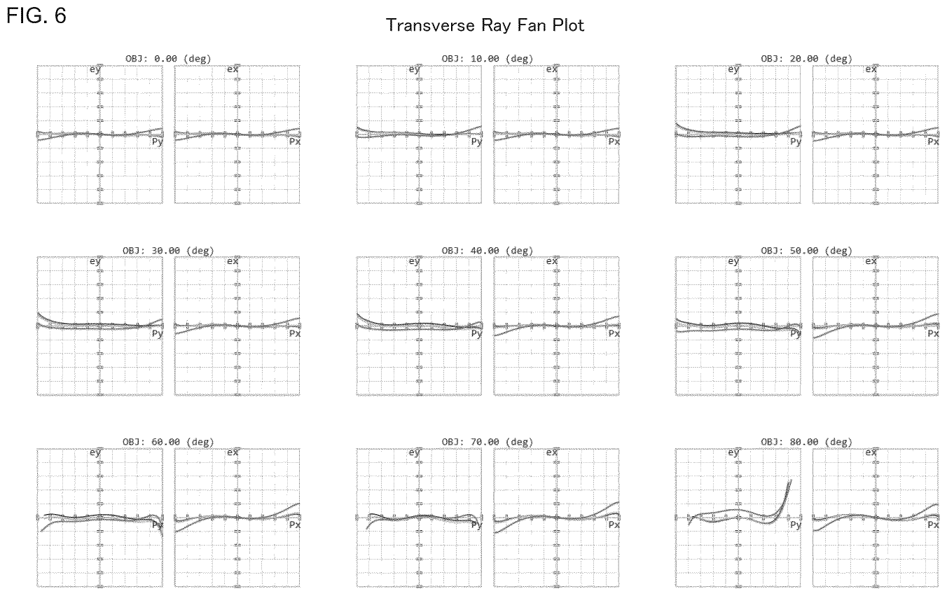

FIG. 3 is a diagram showing spherical aberration of the imaging optical system 100 illustrated in FIG. 1. FIG. 4 is a diagram showing chromatic aberration of magnification of the imaging optical system 100 illustrated in FIG. 1, and shows the chromatic aberration of magnification at the maximum half field angle (80.000 deg). FIG. 5 is a diagram showing astigmatic aberration and distortion of the imaging optical system 100 illustrated in FIG. 1. FIG. 6 is a diagram showing transverse aberration of the imaging optical system 100 illustrated in FIG. 1, and shows the transverse aberration in a tangential direction (Y direction) and a sagittal direction (X direction).

In FIGS. 3 to 6, aberration at wavelengths of 486 nm, 588 nm, and 656 nm is denoted by B, G, and R, respectively. As for the astigmatic aberration shown in FIG. 5, the characteristics in the sagittal direction are denoted by S, and the characteristics in the tangential direction are denoted by T.

As shown in FIGS. 3 to 6, in the imaging optical system 100 of the present embodiment, the spherical aberration, the chromatic aberration of magnification, the astigmatic aberration (distortion), and the transverse aberration are corrected to appropriate levels.

### Second Embodiment

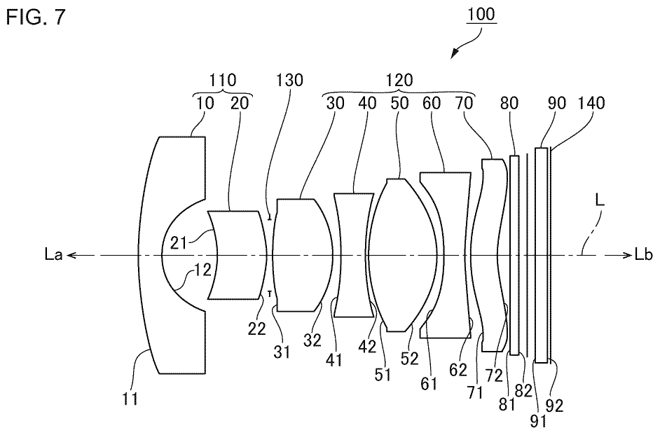

FIG. 7 is an explanatory diagram of the imaging optical system 100 according to a second embodiment. As illustrated in FIG. 7, the imaging optical system 100 of the present embodiment includes, in order from the object side La to the image side Lb, the front group 110, the diaphragm 130, the rear group 120, and the infrared cut filter 80.

The front group 110 includes, in order from the object side La to the image side Lb, the first lens 10 and the second lens 20. The rear group 120 includes, in order from the object side La to the image side Lb, the third lens 30, the fourth lens 40, the fifth lens 50, the sixth lens 60, and the seventh lens 70. On the image side Lb of the seventh lens 70, in order from the object side La to the image side Lb, the plate-like infrared cut filter 80, the translucent cover 90, and the imaging element 140 are arranged. The imaging element 140 is arranged on the imaging plane of the imaging optical system 100 on the image side Lb.

The first lens 10 is made of resin. The first lens 10 has a negative power. The first lens 10 has a convex shape on the lens surface 11 on the object side La, and has a concave shape on the lens surface 12 on the image side Lb. The first lens 10 has an aspherical shape on the lens surface 12.

The second lens 20 is made of resin. The second lens 20 has a negative power. The second lens 20 has a concave shape on the lens surface 21 on the object side La, and has a convex shape on the lens surface 22 on the image side Lb. The second lens 20 has an aspherical shape on both surfaces.

The third lens 30 is made of glass. The third lens 30 has a positive power. The third lens 30 has a convex shape on the lens surface 31 on the object side La, and has a convex shape on the lens surface 32 on the image side Lb.

The fourth lens 40 is made of resin. The fourth lens 40 has a negative power. The fourth lens 40 has a concave shape on the lens surface 41 on the object side La, and has a concave shape on the lens surface 42 on the image side Lb. The fourth lens 40 has an aspherical shape on both surfaces.

The fifth lens 50 is made of resin. The fifth lens 50 has a positive power. The fifth lens 50 has a convex shape on the lens surface 51 on the object side La, and has a convex shape on the lens surface 52 on the image side Lb. The fifth lens 50 has an aspherical shape on both surfaces.

The sixth lens 60 is made of resin. The sixth lens 60 has a negative power. The sixth lens 60 has a concave shape on the lens surface 61 on the object side La, and has a concave shape on the lens surface 62 on the image side Lb. The sixth lens 60 has an aspherical shape on both surfaces.

The seventh lens 70 is made of resin. The seventh lens 70 has a positive power. The seventh lens 70 has a convex shape on the lens surface 71 on the object side La, and has a concave shape on the lens surface 72 on the image side Lb. The seventh lens 70 has an aspherical shape on both surfaces.

### Lens Configuration

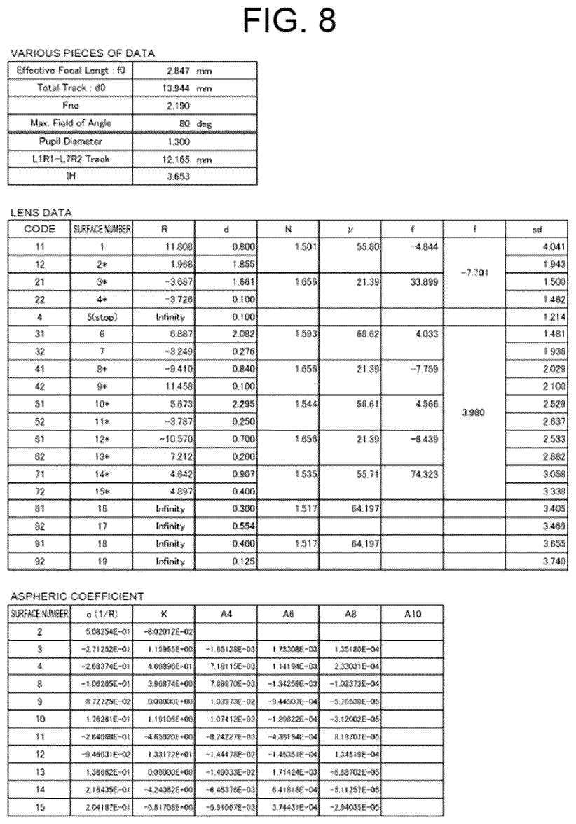

FIG. 8 is a diagram showing data of the imaging optical system 100 of the second embodiment. The imaging optical system 100 of the present embodiment satisfies the conditional expressions (1) to (12) described in the first embodiment.

The following holds in the present embodiment.

$$d 0 = 13.944$$

$$sd 11 = 4.041$$

$$IH = 3.653$$

Thus, d0/sd11=3.451 is obtained, and the conditional expression (1) is satisfied. Moreover, d0/IH=3.817 is obtained, and the conditional expression (2) is satisfied.

The following holds in the present embodiment.

$$sd 11 = 4.041$$

$$IH = 3.653$$

Thus, sd11/IH=1.106 is obtained, and the conditional expression (3) is satisfied.

The following holds in the present embodiment.

$$R 11 = 11.808$$

$$R 12 = 1.968$$

Thus, (R11+R12)/(R11−R12)=1.400 is obtained, and the conditional expression (4) is satisfied.

The following holds in the present embodiment.

$$f 0 = 2.847$$

$$R 11 = 11.808$$

Thus, R11/f0=4.148 is obtained, and the conditional expression (5) is satisfied.

The following holds in the present embodiment.

$$f 0 = 2 \text{.847}$$

$$R 12 = 1.968$$

Thus, R12/f0=0.691 is obtained, and the conditional expression (6) is satisfied.

The following holds in the present embodiment.

$$f 0 = 2.847$$

$$R 21 = - 3 \text{.687}$$

$$R 22 = - 3.726$$

Thus, R21/f0=−1.295 is obtained, and the conditional expression (7) is satisfied. Moreover, R22/f0=−1.309 is obtained, and the conditional expression (8) is satisfied.

The following holds in the present embodiment.

$$v 5 = 56 \text{.61}$$

$$v 6 = 21.39$$

Thus, the conditional expression (9) and the conditional expression (10) are satisfied.

The following holds in the present embodiment.

$$d 0 = 13 \text{.944}$$

$$f 0 = 2.847$$

Thus, d0/f0=4.898 is obtained, and the conditional expression (11) is satisfied.

The following holds in the present embodiment.

$$ω = 160$$

Thus, the conditional expression (12) is satisfied.

### Operation and Effect

Since the imaging optical system 100 of the second embodiment satisfies the conditional expressions (1) to (12) as in the first embodiment, the same effects as those in the first embodiment can be achieved. In the imaging optical system 100 of the present embodiment, the third lens 30 is made of glass, and the fifth lens 50 is made of resin. Accordingly, the temperature characteristics of the imaging optical system 100 are improved.

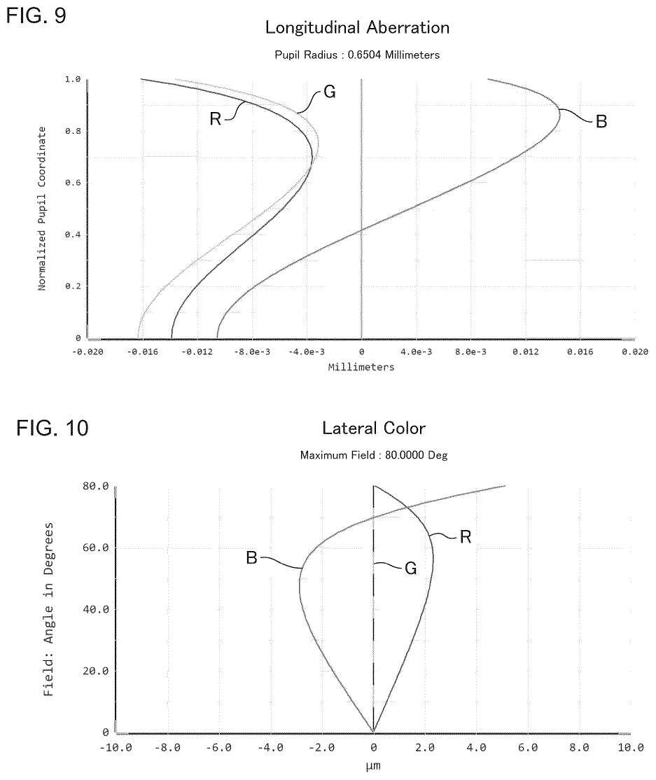

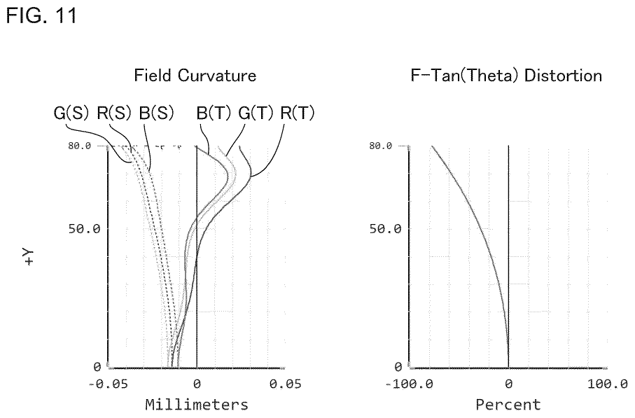

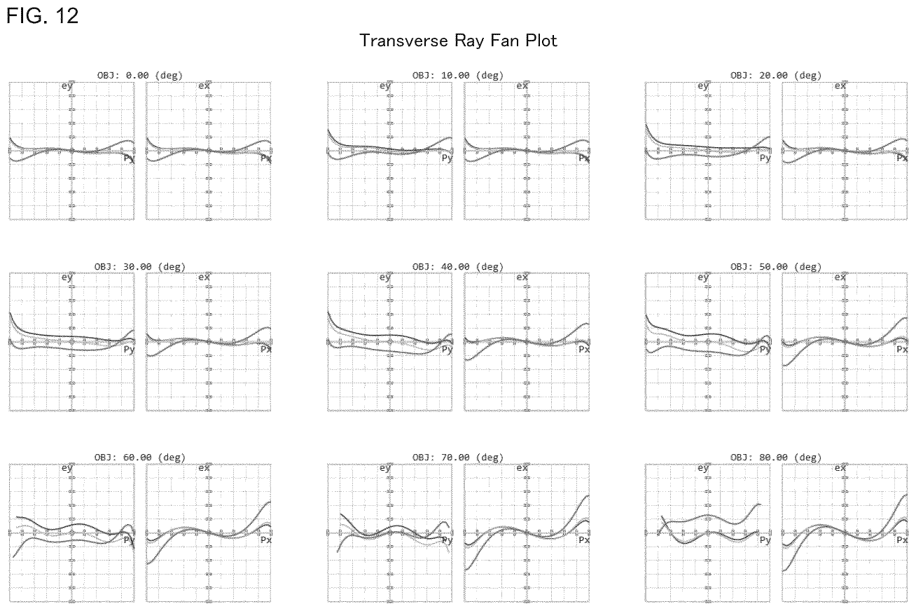

FIG. 9 is a diagram showing spherical aberration of the imaging optical system 100 illustrated in FIG. 7. FIG. 10 is a diagram showing chromatic aberration of magnification of the imaging optical system 100 illustrated in FIG. 7. FIG. 11 is a diagram showing astigmatic aberration and distortion of the imaging optical system 100 illustrated in FIG. 7. FIG. 12 is a diagram showing transverse aberration of the imaging optical system 100 illustrated in FIG. 7.

As shown in FIGS. 9 to 12, in the imaging optical system 100 of the present embodiment, the spherical aberration, the chromatic aberration of magnification, the astigmatic aberration (distortion), the transverse aberration, and the resolution are corrected to appropriate levels.

### Third Embodiment

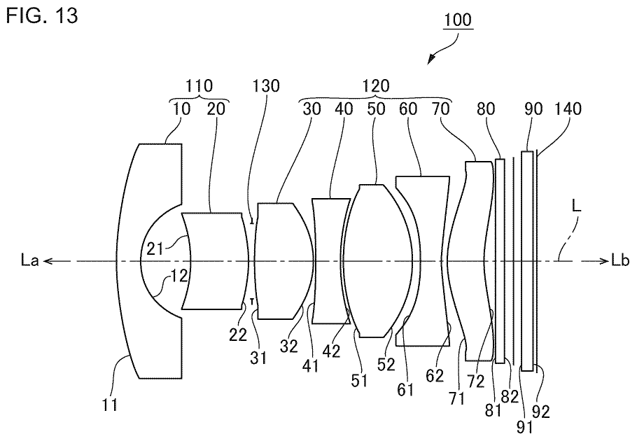

FIG. 13 is an explanatory diagram of the imaging optical system 100 according to a third embodiment. As illustrated in FIG. 13, the imaging optical system 100 of the present embodiment includes, in order from the object side La to the image side Lb, the front group 110, the diaphragm 130, the rear group 120, and the infrared cut filter 80.

The front group 110 includes, in order from the object side La to the image side Lb, the first lens 10 and the second lens 20. The rear group 120 includes, in order from the object side La to the image side Lb, the third lens 30, the fourth lens 40, the fifth lens 50, the sixth lens 60, and the seventh lens 70. On the image side Lb of the seventh lens 70, in order from the object side La to the image side Lb, the plate-like infrared cut filter 80, the translucent cover 90, and the imaging element 140 are arranged. The imaging element 140 is arranged on the imaging plane of the imaging optical system 100 on the image side Lb.

The first lens 10 is made of resin. The first lens 10 has a negative power. The first lens 10 has a convex shape on the lens surface 11 on the object side La, and has a concave shape on the lens surface 12 on the image side Lb. The first lens 10 has an aspherical shape on the lens surface 12.

The second lens 20 is made of resin. The second lens 20 has a positive power. The second lens 20 has a concave shape on the lens surface 21 on the object side La, and has a convex shape on the lens surface 22 on the image side Lb. The second lens 20 has an aspherical shape on both surfaces.

The third lens 30 is made of glass. The third lens 30 has a positive power. The third lens 30 has a convex shape on the lens surface 31 on the object side La, and has a convex shape on the lens surface 32 on the image side Lb.

The fourth lens 40 is made of resin. The fourth lens 40 has a negative power. The fourth lens 40 has a concave shape on the lens surface 41 on the object side La, and has a concave shape on the lens surface 42 on the image side Lb. The fourth lens 40 has an aspherical shape on both surfaces.

The fifth lens 50 is made of resin. The fifth lens 50 has a positive power. The fifth lens 50 has a convex shape on the lens surface 51 on the object side La, and has a convex shape on the lens surface 52 on the image side Lb. The fifth lens 50 has an aspherical shape on both surfaces.

The sixth lens 60 is made of resin. The sixth lens 60 has a negative power. The sixth lens 60 has a concave shape on the lens surface 61 on the object side La, and has a concave shape on the lens surface 62 on the image side Lb. The sixth lens 60 has an aspherical shape on both surfaces.

The seventh lens 70 is made of resin. The seventh lens 70 has a positive power. The seventh lens 70 has a convex shape on the lens surface 71 on the object side La, and has a concave shape on the lens surface 72 on the image side Lb. The seventh lens 70 has an aspherical shape on both surfaces.

### Lens Configuration

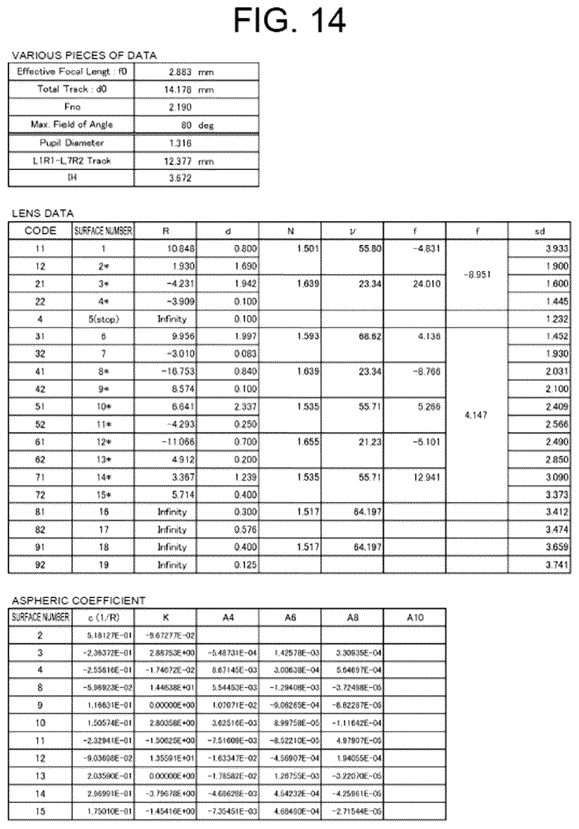

FIG. 14 is a diagram showing data of the imaging optical system 100 of the third embodiment. The imaging optical system 100 of the present embodiment satisfies the conditional expressions (1) to (12) described in the first embodiment.

The following holds in the present embodiment.

$$d 0 = 14.1 \; 78$$

$$sd 11 = 3.933$$

$$IH = 3.672$$

Thus, d0/sd11=3.605 is obtained, and the conditional expression (1) is satisfied. Moreover, d0/IH=3.861 is obtained, and the conditional expression (2) is satisfied.

The following holds in the present embodiment.

$$sd 11 = 3 \text{.933}$$

$$IH = 3.672$$

Thus, sd11/IH=1.071 is obtained, and the conditional expression (3) is satisfied.

The following holds in the present embodiment.

$$R 11 = 10 \text{.848}$$

$$R 12 = 1.93$$

Thus, (R11+R12)/(R11−R12)=1.433 is obtained, and the conditional expression (4) is satisfied.

The following holds in the present embodiment.

$$f 0 = 2 \text{.883}$$

$$R 11 = 10.848$$

Thus, R11/f0=3.763 is obtained, and the conditional expression (5) is satisfied.

The following holds in the present embodiment.

$$f 0 = 2.883 \\ R 12 = 1.93$$

Thus, R12/f0=0.669 is obtained, and the conditional expression (6) is satisfied.

The following holds in the present embodiment.

$$f 0 = 2 \text{.883} \\ R21 = - 4 \text{.231} \\ R 22 = - 3.909$$

Thus, R21/f0=−1.467 is obtained, and the conditional expression (7) is satisfied. Moreover, R22/f0=−1.356 is obtained, and the conditional expression (8) is satisfied.

The following holds in the present embodiment.

$$v 5 = 55.71 v 6 = 21.23$$

Thus, the conditional expression (9) and the conditional expression (10) are satisfied.

The following holds in the present embodiment.

$$d 0 = 14.178 f 0 = 2.883$$

Thus, d0 /f0=4.918 is obtained, and the conditional expression (11) is satisfied.

The following holds in the present embodiment.

$$ω = 160$$

Thus, the conditional expression (12) is satisfied.

### Operation and Effect

Since the imaging optical system 100 of the third embodiment satisfies the conditional expressions (1) to (12) as in the first embodiment, the same effects as those in the first embodiment can be achieved. In the imaging optical system 100 of the present embodiment, the third lens 30 is made of glass, and the fifth lens 50 is made of resin. Accordingly, the temperature characteristics of the imaging optical system 100 are improved.

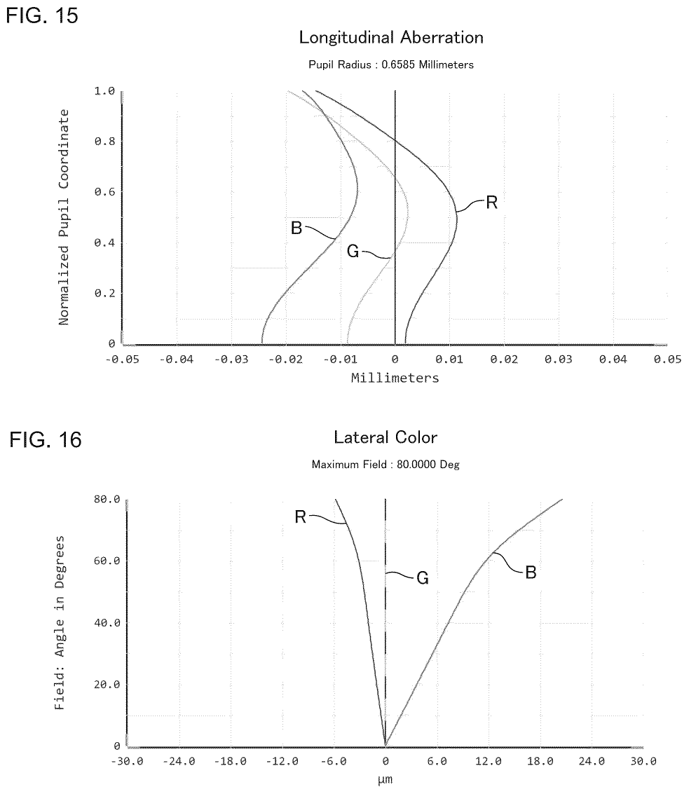

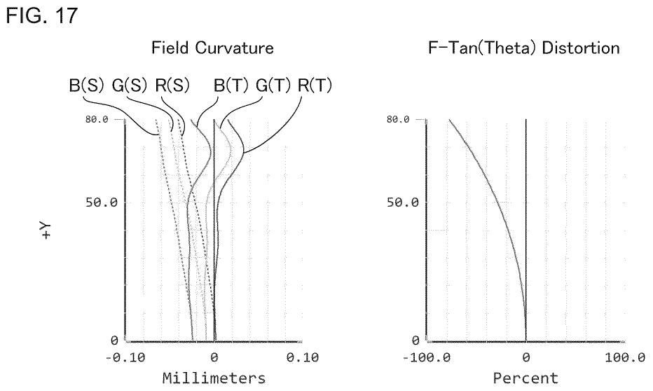

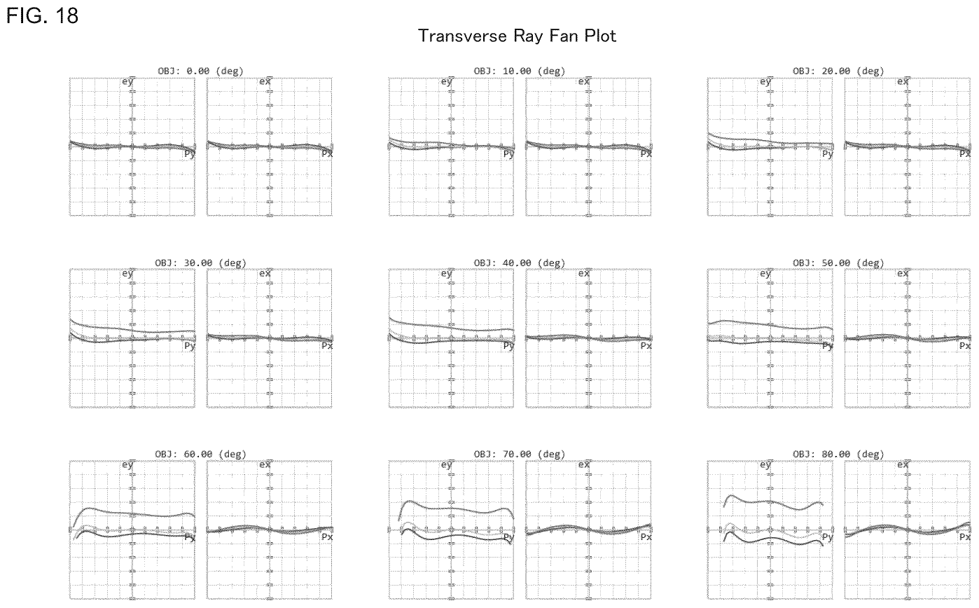

FIG. 15 is a diagram showing spherical aberration of the imaging optical system 100 illustrated in FIG. 13. FIG. 16 is a diagram showing chromatic aberration of magnification of the imaging optical system 100 illustrated in FIG. 13. FIG. 17 is a diagram showing astigmatic aberration and distortion of the imaging optical system 100 illustrated in FIG. 13. FIG. 18 is a diagram showing transverse aberration of the imaging optical system 100 illustrated in FIG. 13.

As shown in FIGS. 15 to 18, in the imaging optical system 100 of the present embodiment, the spherical aberration, the chromatic aberration of magnification, the astigmatic aberration (distortion), the transverse aberration, and the resolution are corrected to appropriate levels.

### Fourth Embodiment

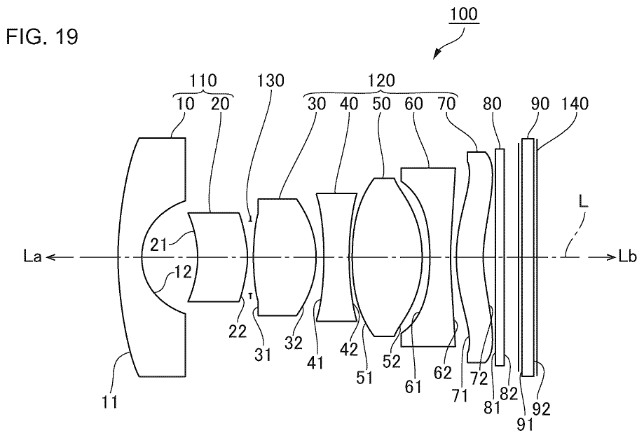

FIG. 19 is an explanatory diagram of the imaging optical system 100 according to a fourth embodiment. As illustrated in FIG. 19, the imaging optical system 100 of the present embodiment includes, in order from the object side La to the image side Lb, the front group 110, the diaphragm 130, the rear group 120, and the infrared cut filter 80.

The front group 110 includes, in order from the object side La to the image side Lb, the first lens 10 and the second lens 20. The rear group 120 includes, in order from the object side La to the image side Lb, the third lens 30, the fourth lens 40, the fifth lens 50, the sixth lens 60, and the seventh lens 70. On the image side Lb of the seventh lens 70, in order from the object side La to the image side Lb, the plate-like infrared cut filter 80, the translucent cover 90, and the imaging element 140 are arranged. The imaging element 140 is arranged on the imaging plane of the imaging optical system 100 on the image side Lb.

The first lens 10 is made of resin. The first lens 10 has a negative power. The first lens 10 has a convex shape on the lens surface 11 on the object side La, and has a concave shape on the lens surface 12 on the image side Lb. The first lens 10 has an aspherical shape on the lens surface 12.

The second lens 20 is made of resin. The second lens 20 has a negative power. The second lens 20 has a concave shape on the lens surface 21 on the object side La, and has a convex shape on the lens surface 22 on the image side Lb. The second lens 20 has an aspherical shape on both surfaces.

The third lens 30 is made of glass. The third lens 30 has a positive power. The third lens 30 has a convex shape on the lens surface 31 on the object side La, and has a convex shape on the lens surface 32 on the image side Lb.

The fourth lens 40 is made of resin. The fourth lens 40 has a negative power. The fourth lens 40 has a concave shape on the lens surface 41 on the object side La, and has a concave shape on the lens surface 42 on the image side Lb. The fourth lens 40 has an aspherical shape on both surfaces.

The fifth lens 50 is made of resin. The fifth lens 50 has a positive power. The fifth lens 50 has a convex shape on the lens surface 51 on the object side La, and has a convex shape on the lens surface 52 on the image side Lb. The fifth lens 50 has an aspherical shape on both surfaces.

The sixth lens 60 is made of resin. The sixth lens 60 has a negative power. The sixth lens 60 has a concave shape on the lens surface 61 on the object side La, and has a concave shape on the lens surface 62 on the image side Lb. The sixth lens 60 has an aspherical shape on both surfaces.

The seventh lens 70 is made of resin. The seventh lens 70 has a positive power. The seventh lens 70 has a convex shape on the lens surface 71 on the object side La, and has a concave shape on the lens surface 72 on the image side Lb. The seventh lens 70 has an aspherical shape on both surfaces.

### Lens Configuration

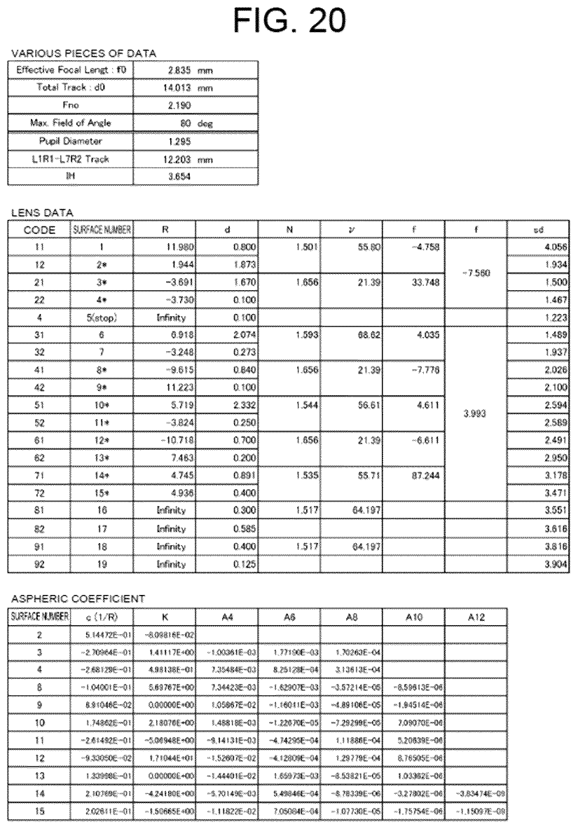

FIG. 20 is a diagram showing data of the imaging optical system 100 of the fourth embodiment. The imaging optical system 100 of the present embodiment satisfies the conditional expressions (1) to (12) described in the first embodiment.

The following holds in the present embodiment.

$$d 0 = 14.013 \\ sd 11 = 4.056 \\ IH = 3.654$$

Thus, d0/sd11=3.455 is obtained, and the conditional expression (1) is satisfied. Moreover, d0/IH=3.835 is obtained, and the conditional expression (2) is satisfied.

The following holds in the present embodiment.

$$sd 11 = 4.056 \\ IH = 3.654$$

Thus, sd11/IH=1.110 is obtained, and the conditional expression (3) is satisfied.

The following holds in the present embodiment.

$$R 11 = 11.98 \\ R 12 = 1.944$$

Thus, (R11+R12)/(R11−R12)=1.387 is obtained, and the conditional expression (4) is satisfied.

The following holds in the present embodiment.

$$f 0 = 2.835 \\ R 11 = 11.98$$

Thus, R11/f0=4.225 is obtained, and the conditional expression (5) is satisfied.

The following holds in the present embodiment.

$$f 0 = 2.835 \\ R 12 = 1.944$$

Thus, R12/f0=0.686 is obtained, and the conditional expression (6) is satisfied.

The following holds in the present embodiment.

$$f 0 = 2.835 \\ R21 = - 3.691 \\ R 22 = - 3.730$$

Thus, R21/f0=−1.302 is obtained, and the conditional expression (7) is satisfied. Moreover, R22/f0 =-1.315 is obtained, and the conditional expression (8) is satisfied.

The following holds in the present embodiment.

$$v 5 = 56.61 v 6 = 21.39$$

Thus, the conditional expression (9) and the conditional expression (10) are satisfied.

The following holds in the present embodiment.

$$d 0 = 14.013 f 0 = 2.835$$

Thus, d0/f0=4.942 is obtained, and the conditional expression (11) is satisfied.

The following holds in the present embodiment.

$$ω = 160$$

Thus, the conditional expression (12) is satisfied.

### Operation and Effect

Since the imaging optical system 100 of the fourth embodiment satisfies the conditional expressions (1) to (12) as in the first embodiment, the same effects as those in the first embodiment can be achieved. In the imaging optical system 100 of the present embodiment, the third lens 30 is made of glass, and the fifth lens 50 is made of resin. Accordingly, the temperature characteristics of the imaging optical system 100 are improved.

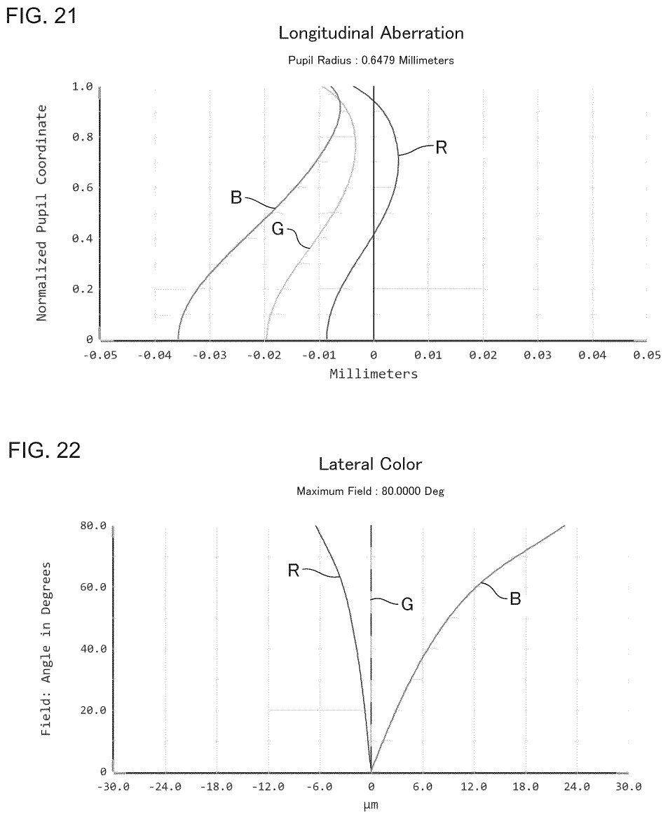

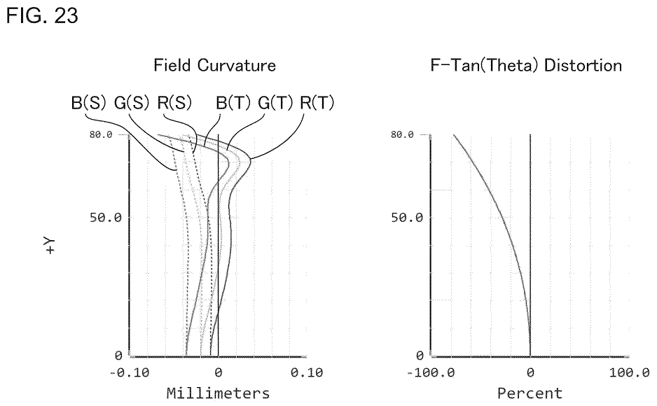

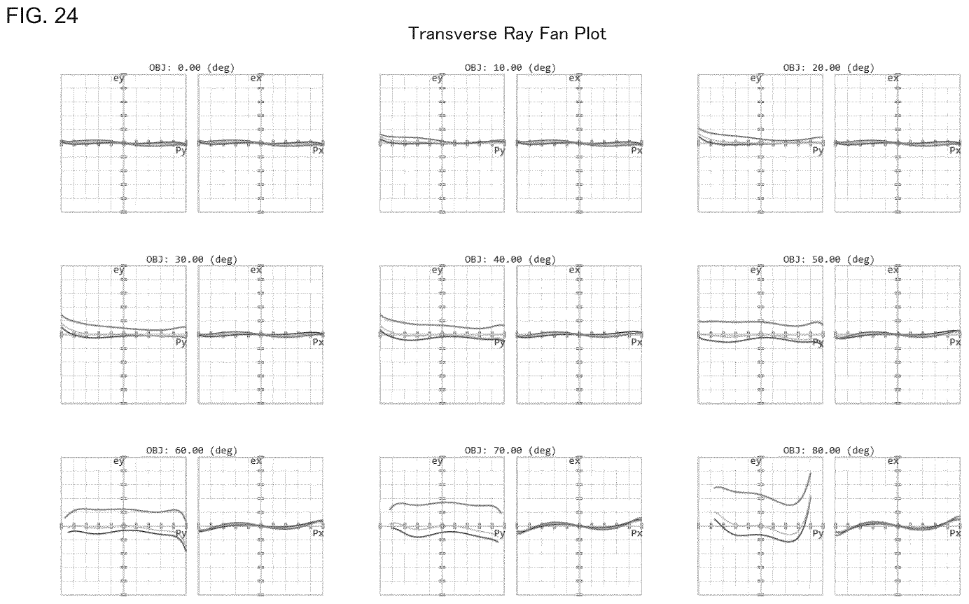

FIG. 21 is a diagram showing spherical aberration of the imaging optical system 100 illustrated in FIG. 19. FIG. 22 is a diagram showing chromatic aberration of magnification of the imaging optical system 100 illustrated in FIG. 19. FIG. 23 is a diagram showing astigmatic aberration and distortion of the imaging optical system 100 illustrated in FIG. 19. FIG. 24 is a diagram showing transverse aberration of the imaging optical system 100 illustrated in FIG. 19.

As shown in FIGS. 21 to 24, in the imaging optical system 100 of the present embodiment, the spherical aberration, the chromatic aberration of magnification, the astigmatic aberration (distortion), the transverse aberration, and the resolution are corrected to appropriate levels.

### Fifth Embodiment

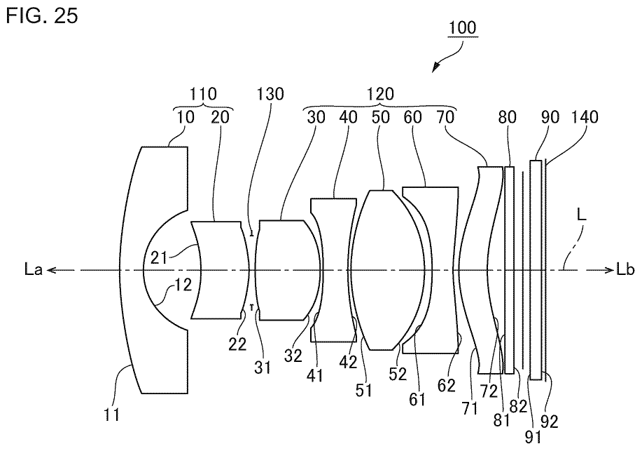

FIG. 25 is an explanatory diagram of the imaging optical system 100 according to a fifth embodiment. As illustrated in FIG. 25, the imaging optical system 100 of the present embodiment includes, in order from the object side La to the image side Lb, the front group 110, the diaphragm 130, the rear group 120, and the infrared cut filter 80.

The front group 110 includes, in order from the object side La to the image side Lb, the first lens 10 and the second lens 20. The rear group 120 includes, in order from the object side La to the image side Lb, the third lens 30, the fourth lens 40, the fifth lens 50, the sixth lens 60, and the seventh lens 70. On the image side Lb of the seventh lens 70, in order from the object side La to the image side Lb, the plate-like infrared cut filter 80, the translucent cover 90, and the imaging element 140 are arranged. The imaging element 140 is arranged on the imaging plane of the imaging optical system 100 on the image side Lb.

The first lens 10 is made of resin. The first lens 10 has a negative power. The first lens 10 has a convex shape on the lens surface 11 on the object side La, and has a concave shape on the lens surface 12 on the image side Lb. The first lens 10 has an aspherical shape on the lens surface 12.

The second lens 20 is made of resin. The second lens 20 has a positive power. The second lens 20 has a concave shape on the lens surface 21 on the object side La, and has a convex shape on the lens surface 22 on the image side Lb. The second lens 20 has an aspherical shape on both surfaces.

The third lens 30 is made of resin. The third lens 30 has a positive power. The third lens 30 has a convex shape on the lens surface 31 on the object side La, and has a convex shape on the lens surface 32 on the image side Lb. The third lens 30 has an aspherical shape on both surfaces.

The fourth lens 40 is made of resin. The fourth lens 40 has a negative power. The fourth lens 40 has a concave shape on the lens surface 41 on the object side La, and has a concave shape on the lens surface 42 on the image side Lb. The fourth lens 40 has an aspherical shape on both surfaces.

The fifth lens 50 is made of glass. The fifth lens 50 has a positive power. The fifth lens 50 has a convex shape on the lens surface 51 on the object side La, and has a convex shape on the lens surface 52 on the image side Lb.

The sixth lens 60 is made of resin. The sixth lens 60 has a negative power. The sixth lens 60 has a concave shape on the lens surface 61 on the object side La, and has a concave shape on the lens surface 62 on the image side Lb. The sixth lens 60 has an aspherical shape on both surfaces.

The seventh lens 70 is made of resin. The seventh lens 70 has a positive power. The seventh lens 70 has a convex shape on the lens surface 71 on the object side La, and has a concave shape on the lens surface 72 on the image side Lb. The seventh lens 70 has an aspherical shape on both surfaces.

### Lens Configuration

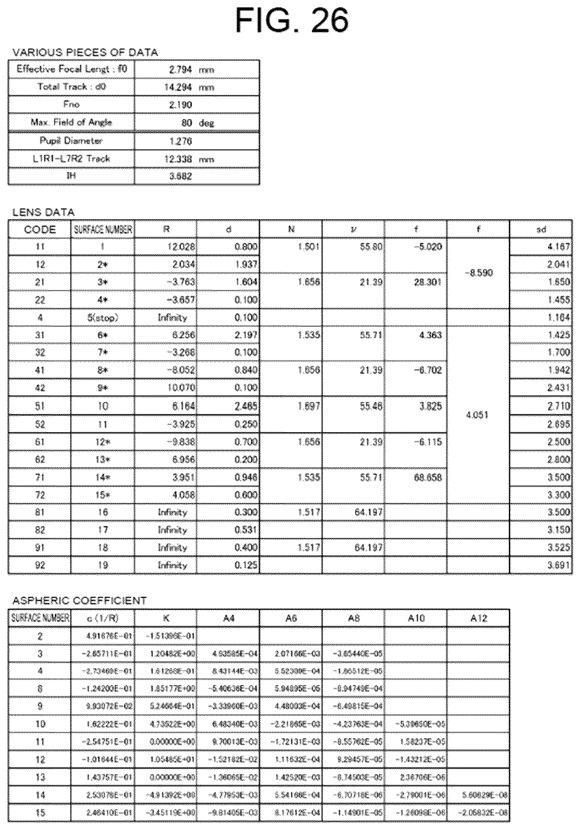

FIG. 26 is a diagram showing data of the imaging optical system 100 of the fifth embodiment. The imaging optical system 100 of the present embodiment satisfies the conditional expressions (1) to (12) described in the first embodiment.

The following holds in the present embodiment.

$$d 0 = 14.294 \\ sd 11 = 4.167 \\ IH = 3.682$$

Thus, d0/sd11=3.430 is obtained, and the conditional expression (1) is satisfied. Moreover, d0/IH=3.882 is obtained, and the conditional expression (2) is satisfied.

The following holds in the present embodiment.

$$sd 11 = 4.167$$

$$IH = 3.682$$

Thus, sd11/IH=1.132 is obtained, and the conditional expression (3) is satisfied.

The following holds in the present embodiment.

$$R 11 = 12.028$$

$$R 12 = 2.034$$

Thus, (R11+R12)/(R11−R12)=1.407 is obtained, and the conditional expression (4) is satisfied.

The following holds in the present embodiment.

$$f 0 = 2 \text{.794}$$

$$R 11 = 12.028$$

Thus, R11/f0=4.305 is obtained, and the conditional expression (5) is satisfied.

The following holds in the present embodiment.

$$f 0 = 2 \text{.794}$$

$$R 12 = 2.034$$

Thus, R12/f0=0.728 is obtained, and the conditional expression (6) is satisfied.

The following holds in the present embodiment.

$$f 0 = 2 \text{.794}$$

$$R 21 = - 3.7 \; 63$$

$$R 22 = - 3.657$$

Thus, R21/f0=−1.347 is obtained, and the conditional expression (7) is satisfied. Moreover, R22/f0=−1.309 is obtained, and the conditional expression (8) is satisfied.

The following holds in the present embodiment.

$$v 5 = 55.46$$

$$v 6 = 21.39$$

Thus, the conditional expression (9) and the conditional expression (10) are satisfied.

The following holds in the present embodiment.

$$d 0 = 14 \text{.294}$$

$$f 0 = 2.794$$

Thus, d0/f0=5.116 is obtained, and the conditional expression (11) is satisfied.

The following holds in the present embodiment.

$$ω = 160$$

Thus, the conditional expression (12) is satisfied.

### Operation and Effect

Since the imaging optical system 100 of the fifth embodiment satisfies the conditional expressions (1) to (12) as in the first embodiment, the same effects as those in the first embodiment can be achieved. In the imaging optical system 100 of the present embodiment, the third lens 30 is made of resin, and the fifth lens 50 is made of glass. Accordingly, the temperature characteristics of the imaging optical system 100 are improved.

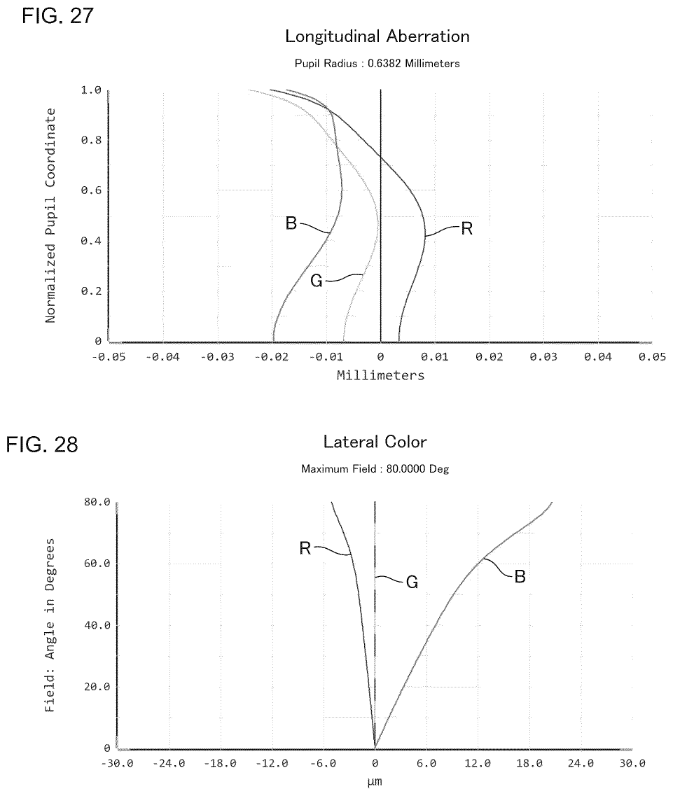

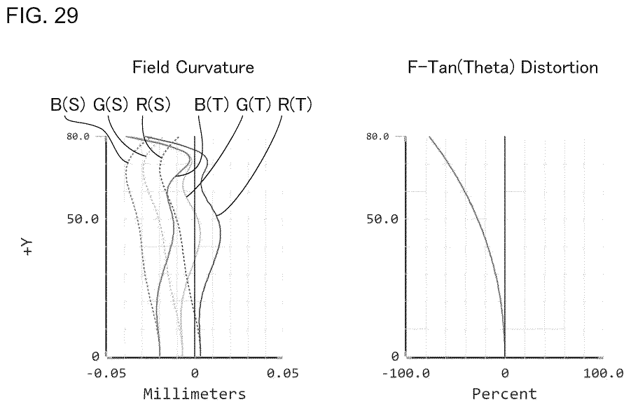

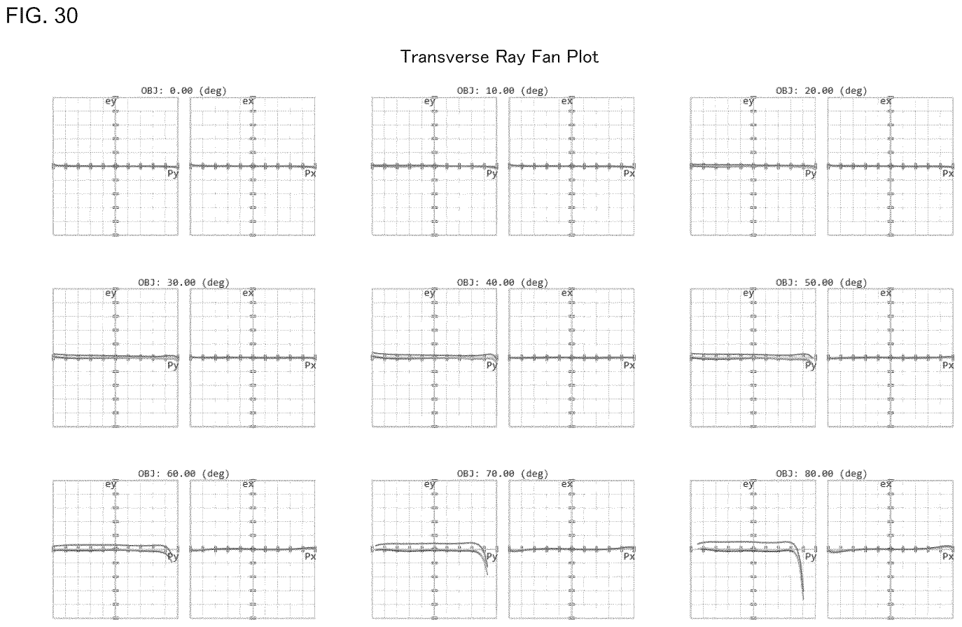

FIG. 27 is a diagram showing spherical aberration of the imaging optical system 100 illustrated in FIG. 25. FIG. 28 is a diagram showing chromatic aberration of magnification of the imaging optical system 100 illustrated in FIG. 25. FIG. 29 is a diagram showing astigmatic aberration and distortion of the imaging optical system 100 illustrated in FIG. 25. FIG. 30 is a diagram showing transverse aberration of the imaging optical system 100 illustrated in FIG. 25.

As shown in FIGS. 27 to 30, in the imaging optical system 100 of the present embodiment, the spherical aberration, the chromatic aberration of magnification, the astigmatic aberration (distortion), the transverse aberration, and the resolution are corrected to appropriate levels.

### Sixth Embodiment

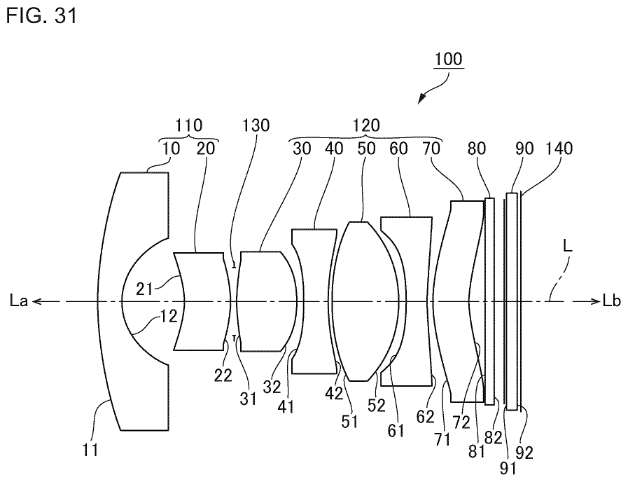

FIG. 31 is an explanatory diagram of the imaging optical system 100 according to a sixth embodiment. As illustrated in FIG. 31, the imaging optical system 100 of the present embodiment includes, in order from the object side La to the image side Lb, the front group 110, the diaphragm 130, the rear group 120, and the infrared cut filter 80.

The front group 110 includes, in order from the object side La to the image side Lb, the first lens 10 and the second lens 20. The rear group 120 includes, in order from the object side La to the image side Lb, the third lens 30, the fourth lens 40, the fifth lens 50, the sixth lens 60, and the seventh lens 70. On the image side Lb of the seventh lens 70, in order from the object side La to the image side Lb, the plate-like infrared cut filter 80, the translucent cover 90, and the imaging element 140 are arranged. The imaging element 140 is arranged on the imaging plane of the imaging optical system 100 on the image side Lb.

The first lens 10 is made of resin. The first lens 10 has a negative power. The first lens 10 has a convex shape on the lens surface 11 on the object side La, and has a concave shape on the lens surface 12 on the image side Lb. The first lens 10 has an aspherical shape on the lens surface 12.

The second lens 20 is made of resin. The second lens 20 has a positive power. The second lens 20 has a concave shape on the lens surface 21 on the object side La, and has a convex shape on the lens surface 22 on the image side Lb. The second lens 20 has an aspherical shape on both surfaces.

The third lens 30 is made of resin. The third lens 30 has a positive power. The third lens 30 has a convex shape on the lens surface 31 on the object side La, and has a convex shape on the lens surface 32 on the image side Lb. The third lens 30 has an aspherical shape on both surfaces.

The fourth lens 40 is made of resin. The fourth lens 40 has a negative power. The fourth lens 40 has a concave shape on the lens surface 41 on the object side La, and has a concave shape on the lens surface 42 on the image side Lb. The fourth lens 40 has an aspherical shape on both surfaces.

The fifth lens 50 is made of glass. The fifth lens 50 has a positive power. The fifth lens 50 has a convex shape on the lens surface 51 on the object side La, and has a convex shape on the lens surface 52 on the image side Lb.

The sixth lens 60 is made of resin. The sixth lens 60 has a negative power. The sixth lens 60 has a concave shape on the lens surface 61 on the object side La, and has a concave shape on the lens surface 62 on the image side Lb. The sixth lens 60 has an aspherical shape on both surfaces.

The seventh lens 70 is made of resin. The seventh lens 70 has a negative power. The seventh lens 70 has a convex shape on the lens surface 71 on the object side La, and has a concave shape on the lens surface 72 on the image side Lb. The seventh lens 70 has an aspherical shape on both surfaces.

### Lens Configuration

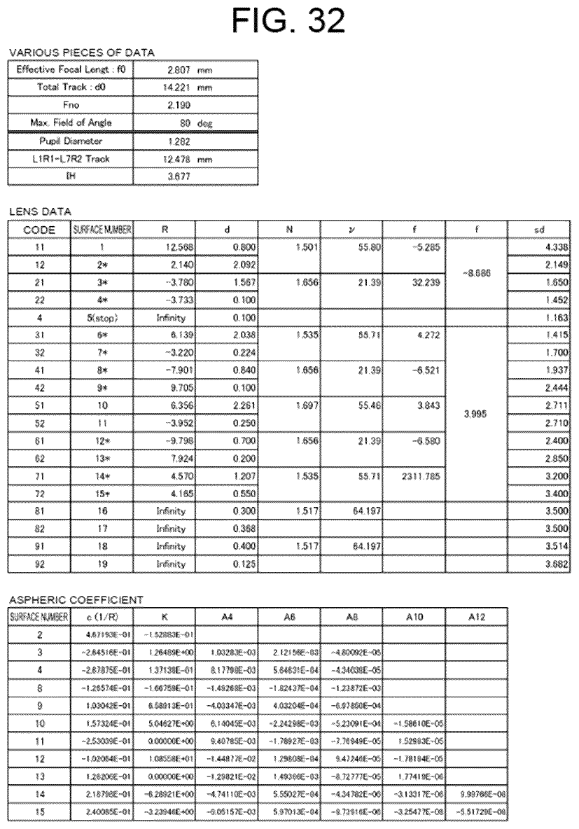

FIG. 32 is a diagram showing data of the imaging optical system 100 of the sixth embodiment. The imaging optical system 100 of the present embodiment satisfies the conditional expressions (1) to (12) described in the first embodiment.

The following holds in the present embodiment.

$$d 0 = 14 \text{.221}$$

$$sd 11 = 4.338$$

$$IH = 3.677$$

Thus, d0/sd11=3.278 is obtained, and the conditional expression (1) is satisfied. Moreover, d0/IH=3.868 is obtained, and the conditional expression (2) is satisfied.

The following holds in the present embodiment.

$$sd 11 = 4.338$$

$$IH = 3.677$$

Thus, sd11/IH=1.180 is obtained, and the conditional expression (3) is satisfied.

The following holds in the present embodiment.

$$R 11 = 12.568$$

$$R 12 = 2.14$$

Thus, (R11+R12)/(R11−R12)=1.411 is obtained, and the conditional expression (4) is satisfied.

The following holds in the present embodiment.

$$f 0 = 2 \text{.807}$$

$$R 11 = 12.568$$

Thus, R11/f0=4.476 is obtained, and the conditional expression (5) is satisfied.

The following holds in the present embodiment.

$$f 0 = 2 \text{.807}$$

$$R 12 = 2.14$$

Thus, R12/f0=0.762 is obtained, and the conditional expression (6) is satisfied.

The following holds in the present embodiment.

$$f 0 = 2 \text{.807}$$

$$R 21 = - 3.7 \; 80$$

$$R 22 = - 3.733$$

Thus, R21/f0=−1.347 is obtained, and the conditional expression (7) is satisfied. Moreover, R22/f0=−1.330 is obtained, and the conditional expression (8) is satisfied.

The following holds in the present embodiment.

$$v 5 = 55 \text{.46}$$

$$v 6 = 21.39$$

Thus, the conditional expression (9) and the conditional expression (10) are satisfied.

The following holds in the present embodiment.

$$d 0 = 14.221 f 0 = 2.807$$

Thus, d0/f0=5.066 is obtained, and the conditional expression (11) is satisfied.

The following holds in the present embodiment.

$$ω = 160$$

Thus, the conditional expression (12) is satisfied.

### Operation and Effect

Since the imaging optical system 100 of the sixth embodiment satisfies the conditional expressions (1) to (12) as in the first embodiment, the same effects as those in the first embodiment can be achieved. In the imaging optical system 100 of the present embodiment, the third lens 30 is made of resin, and the fifth lens 50 is made of glass. Accordingly, the temperature characteristics of the imaging optical system 100 are improved.

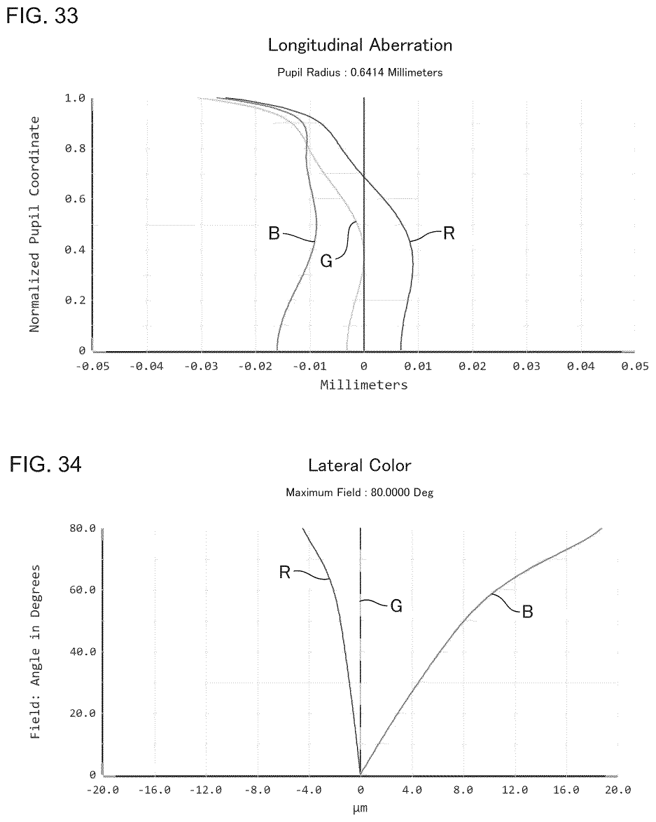

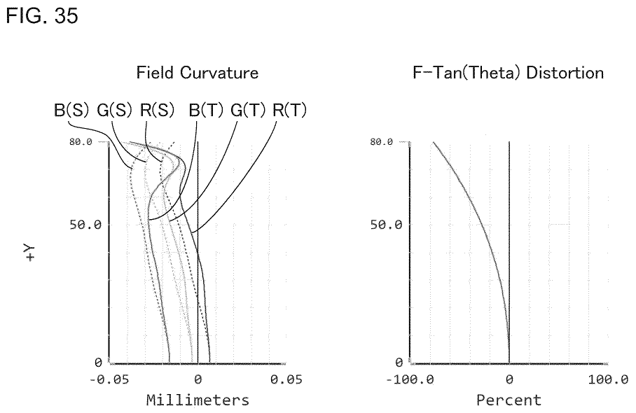

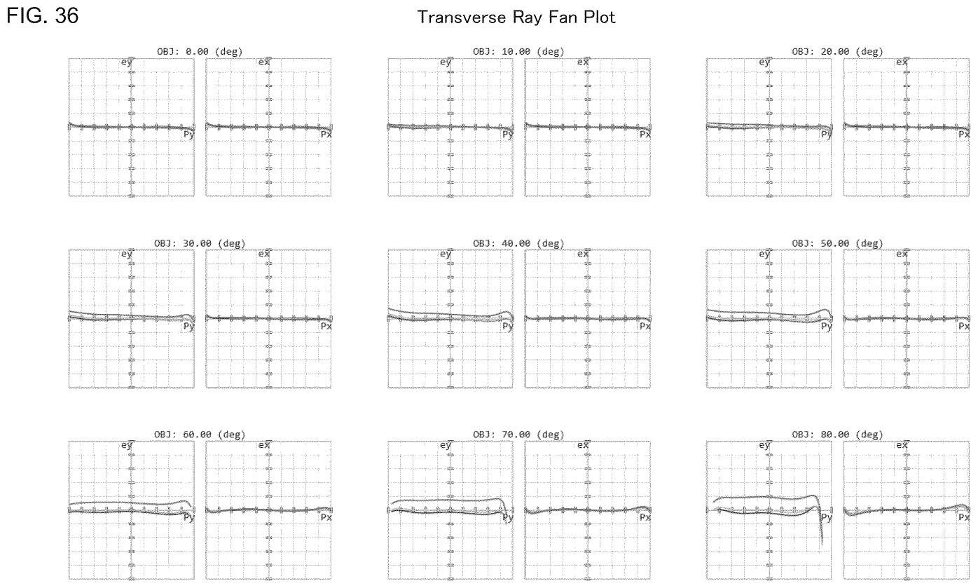

FIG. 33 is a diagram showing spherical aberration of the imaging optical system 100 illustrated in FIG. 31. FIG. 34 is a diagram showing chromatic aberration of magnification of the imaging optical system 100 illustrated in FIG. 31. FIG. 35 is a diagram showing astigmatic aberration and distortion of the imaging optical system 100 illustrated in FIG. 31. FIG. 36 is a diagram showing transverse aberration of the imaging optical system 100 illustrated in FIG. 31.

As shown in FIGS. 33 to 36, in the imaging optical system 100 of the present embodiment, the spherical aberration, the chromatic aberration of magnification, the astigmatic aberration (distortion), the transverse aberration, and the resolution are corrected to appropriate levels.

### Seventh Embodiment

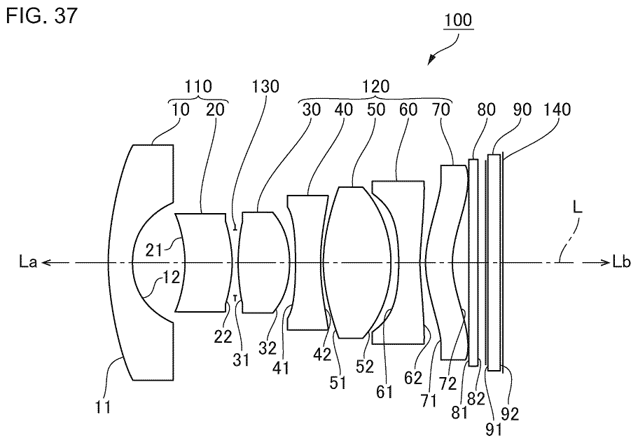

FIG. 37 is an explanatory diagram of the imaging optical system 100 according to a seventh embodiment. As illustrated in FIG. 37, the imaging optical system 100 of the present embodiment includes, in order from the object side La to the image side Lb, the front group 110, the diaphragm 130, the rear group 120, and the infrared cut filter 80.

The front group 110 includes, in order from the object side La to the image side Lb, the first lens 10 and the second lens 20. The rear group 120 includes, in order from the object side La to the image side Lb, the third lens 30, the fourth lens 40, the fifth lens 50, the sixth lens 60, and the seventh lens 70. On the image side Lb of the seventh lens 70, in order from the object side La to the image side Lb, the plate-like infrared cut filter 80, the translucent cover 90, and the imaging element 140 are arranged. The imaging element 140 is arranged on the imaging plane of the imaging optical system 100 on the image side Lb.

The first lens 10 is made of resin. The first lens 10 has a negative power. The first lens 10 has a convex shape on the lens surface 11 on the object side La, and has a concave shape on the lens surface 12 on the image side Lb. The first lens 10 has an aspherical shape on the lens surface 12.

The second lens 20 is made of resin. The second lens 20 has a positive power. The second lens 20 has a concave shape on the lens surface 21 on the object side La, and has a convex shape on the lens surface 22 on the image side Lb. The second lens 20 has an aspherical shape on both surfaces.

The third lens 30 is made of resin. The third lens 30 has a positive power. The third lens 30 has a convex shape on the lens surface 31 on the object side La, and has a convex shape on the lens surface 32 on the image side Lb. The third lens 30 has an aspherical shape on both surfaces.

The fourth lens 40 is made of resin. The fourth lens 40 has a negative power. The fourth lens 40 has a concave shape on the lens surface 41 on the object side La, and has a concave shape on the lens surface 42 on the image side Lb. The fourth lens 40 has an aspherical shape on both surfaces.

The fifth lens 50 is made of glass. The fifth lens 50 has a positive power. The fifth lens 50 has a convex shape on the lens surface 51 on the object side La, and has a convex shape on the lens surface 52 on the image side Lb.

The sixth lens 60 is made of resin. The sixth lens 60 has a negative power. The sixth lens 60 has a concave shape on the lens surface 61 on the object side La, and has a concave shape on the lens surface 62 on the image side Lb. The sixth lens 60 has an aspherical shape on both surfaces.

The seventh lens 70 is made of resin. The seventh lens 70 has a negative power. The seventh lens 70 has a convex shape on the lens surface 71 on the object side La, and has a concave shape on the lens surface 72 on the image side Lb. The seventh lens 70 has an aspherical shape on both surfaces.

### Lens Configuration

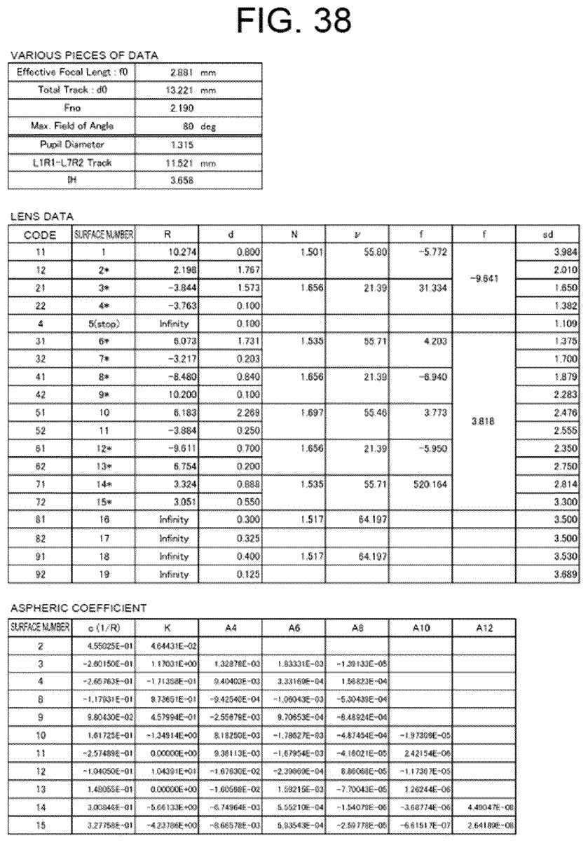

FIG. 38 is a diagram showing data of the imaging optical system 100 of the seventh embodiment. The imaging optical system 100 of the present embodiment satisfies the conditional expressions (1) to (12) described in the first embodiment.

The following holds in the present embodiment.

$$d 0 = 13.221 \\ sd 11 = 3.984 \\ IH = 3.658$$

Thus, d0/sd11=3.318 is obtained, and the conditional expression (1) is satisfied. Moreover, d0/IH=3.614 is obtained, and the conditional expression (2) is satisfied.

The following holds in the present embodiment.

$$sd 11 = 3.984 \\ IH = 3.658$$

Thus, sd11/IH=1.089 is obtained, and the conditional expression (3) is satisfied.

The following holds in the present embodiment.

$$R 11 = 10.274 \\ R 12 = 2.198$$

Thus, (R11+R12)/(R11−R12)=1.544 is obtained, and the conditional expression (4) is satisfied.

The following holds in the present embodiment.

$$f 0 = 2.881 \\ R 11 = 10.274$$

Thus, R11/f0=3.567 is obtained, and the conditional expression (5) is satisfied.

The following holds in the present embodiment.

$$f 0 = 2.881 \\ R 12 = 2.198$$

Thus, R12/f0=0.763 is obtained, and the conditional expression (6) is satisfied.

The following holds in the present embodiment.

$$f 0 = 2.881 \\ R 21 = - 3.844 \\ R 22 = - 3.763$$

Thus, R21/f0=−1.334 is obtained, and the conditional expression (7) is satisfied. Moreover, R22/f0=−1.306 is obtained, and the conditional expression (8) is satisfied.

The following holds in the present embodiment.

$$v 5 = 55.46 v 6 = 21.39$$

Thus, the conditional expression (9) and the conditional expression (10) are satisfied.

The following holds in the present embodiment.

$$d 0 = 13.221 f 0 = 2.881$$

Thus, d0/f0=4.590 is obtained, and the conditional expression (11) is satisfied.

The following holds in the present embodiment.

$$ω = 160$$

Thus, the conditional expression (12) is satisfied.

### Operation and Effect

Since the imaging optical system 100 of the seventh embodiment satisfies the conditional expressions (1) to (12) as in the first embodiment, the same effects as those in the first embodiment can be achieved. In the imaging optical system 100 of the present embodiment, the third lens 30 is made of resin, and the fifth lens 50 is made of glass. Accordingly, the temperature characteristics of the imaging optical system 100 are improved.

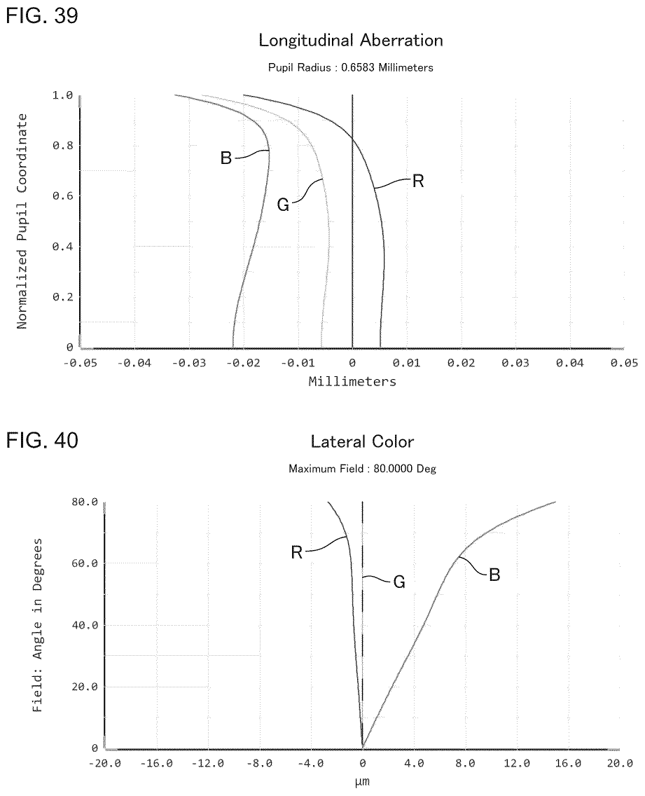

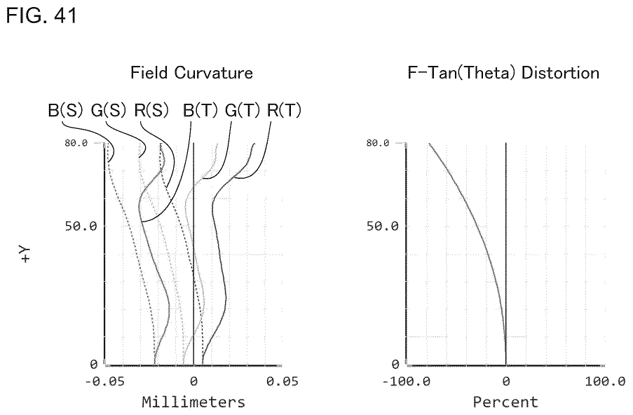

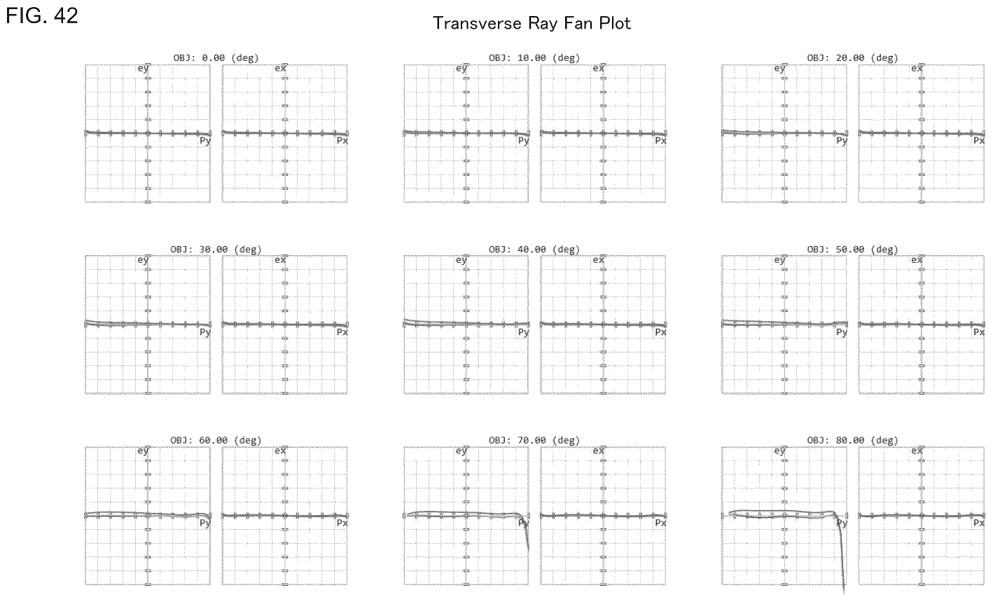

FIG. 39 is a diagram showing spherical aberration of the imaging optical system 100 illustrated in FIG. 37. FIG. 40 is a diagram showing chromatic aberration of magnification of the imaging optical system 100 illustrated in FIG. 37. FIG. 41 is a diagram showing astigmatic aberration and distortion of the imaging optical system 100 illustrated in FIG. 37. FIG. 42 is a diagram showing transverse aberration of the imaging optical system 100 illustrated in FIG. 37.

As shown in FIGS. 39 to 42, in the imaging optical system 100 of the present embodiment, the spherical aberration, the chromatic aberration of magnification, the astigmatic aberration (distortion), the transverse aberration, and the resolution are corrected to appropriate levels.

### The Present Technique Can Be Configured As Follows.

(1) An imaging optical system including: in order from an object side to an image side, a front group;
a diaphragm; and
a rear group, in which
the front group includes a plurality of lenses including a first lens arranged closest to the object side,
the rear group includes a plurality of lenses,
the first lens has a negative power, and,
when a total track of an entire lens system is d0, an effective radius of a lens surface of the first lens on the object side is sd11, and a maximum image height is IH, the following conditional expressions:

$$3. < d 0 / sd 11 < 4.5 \qquad ( 1 )$$

$$2.5 < d 0 / IH < 5. \qquad ( 2 )$$

are satisfied.

(2) The imaging optical system according to (1), in which,
when the effective radius of the lens surface of the first lens on the object side is sd11, and the maximum image height is IH, the following conditional expression:

$$0.65 < sd 11 / IH < 1.3 \qquad ( 3 )$$

is satisfied.

(3) The imaging optical system according to (1) or (2), in which,
when a curvature radius of the lens surface of the first lens on the object side is R11, and a curvature radius of a lens surface of the first lens on the image side is R12, the following conditional expression:

$$1.1 < ( R 11 + R 12 ) / ( R 11 - R 12 ) < 2. \qquad ( 4 )$$

is satisfied.

(4) The imaging optical system according to any one of (1) to (3), in which,
when a focal length of the entire lens system is f0, and the curvature radius of the lens surface of the first lens on the object side is R11, the following conditional expression:

$$2. < R 11 / f 0 < 9. \qquad ( 5 )$$

is satisfied.

(5) The imaging optical system according to any one of (1) to (4), in which,
when the focal length of the entire lens system is f0, and the curvature radius of the lens surface of the first lens on the image side is R12, the following conditional expression:

$$0.5 < R 12 / f 0 < 3. \qquad ( 6 )$$

is satisfied.

(6) The imaging optical system according to any one of (1) to (5), in which
the front group includes, in order from the object side to the image side, the first lens and a second lens, and,
when the focal length of the entire lens system is f0, a curvature radius of a lens surface of the second lens on the object side is R21, and a curvature radius of a lens surface of the second lens on the image side is R22, the following conditional expressions:

$$- 6.000 < R 21 / f0 < - 1.5 \qquad ( 7 )$$

$$- 6. 00 < R 22 / f0 < - 1.5 \qquad ( 8 )$$

are satisfied.

(7) The imaging optical system according to any one of (1) to (6), in which
the front group includes, in order from the object side to the image side, the first lens and the second lens,
the rear group includes, in order from the object side to the image side, a third lens, a fourth lens, a fifth lens, a sixth lens, and a seventh lens,
the third lens has a positive power,
the fourth lens has a negative power,
the fifth lens has a positive power, and
the sixth lens has a negative power.

(8) The imaging optical system according to (7), in which,
when an Abbe number of the fifth lens is v5, and an Abbe number of the sixth lens is v6, the following conditional expressions:

$$50. < v 5 \qquad ( 9 )$$

$$v 6 < 30 \text{.000} \qquad ( 10 )$$

are satisfied.

(9) The imaging optical system according to (7) or (8), in which
the third lens is made of resin, and
the fifth lens is made of glass.

(10) The imaging optical system according to (7) or (8), in which
the third lens is made of glass, and
the fifth lens is made of resin.

What is claimed is:

1. An imaging optical system comprising: in order from an object side to an image side, a front group;
a diaphragm; and
a rear group, wherein
the front group includes a plurality of lenses including a first lens arranged closest to the object side,
the rear group includes a plurality of lenses,
the first lens has a negative power, and,
when a total track of an entire lens system is d0, an effective radius of a lens surface of the first lens on the object side is sd11, and a maximum image height is IH, the following conditional expressions are satisfied:
$$3. < d 0 / sd 11 < 4.5 ; \qquad ( 1 )$$
$$2.5 < d 0 / IH < 5. . \qquad ( 2 )$$

2. The imaging optical system according to claim 1, wherein,
when the effective radius of the lens surface of the first lens on the object side is sd11, and the maximum image height is IH, the following conditional expression is satisfied:
$$0.65 < sd 11 / IH < 1.3 . \qquad ( 3 )$$

3. The imaging optical system according to claim 1, wherein,
when a curvature radius of the lens surface of the first lens on the object side is R11, and a curvature radius of a lens surface of the first lens on the image side is R12, the following conditional expression is satisfied:
$$1.1 < ( R 11 + R 12 ) / ( R 11 - R 12 ) < 2. \qquad ( 4 )$$

4. The imaging optical system according to claim 1, wherein,
when a focal length of the entire lens system is f0, and a curvature radius of the lens surface of the first lens on the object side is R11, the following conditional expression is satisfied:
$$2. < R 11 / f 0 < 9. . \qquad ( 5 )$$

5. The imaging optical system according to claim 1, wherein,
when a focal length of the entire lens system is f0, and a curvature radius of a lens surface of the first lens on the image side is R12, the following conditional expression is satisfied:
$$0.5 < R 12 / f 0 < 3. . \qquad ( 6 )$$

6. The imaging optical system according to claim 1, wherein
the front group includes, in order from the object side to the image side, the first lens and a second lens, and,
when a focal length of the entire lens system is f0, a curvature radius of a lens surface of the second lens on the object side is R21, and a curvature radius of a lens surface of the second lens on the image side is R22, the following conditional expressions are satisfied:
$$- 6.000 < R 21 / f0 < - 1.5 \qquad ( 7 )$$
$$- 6. 00 < R 22 / f0 < - 1.5 . \qquad ( 8 )$$

7. The imaging optical system according to claim 1, wherein
the front group includes, in order from the object side to the image side, the first lens and a second lens,
the rear group includes, in order from the object side to the image side, a third lens, a fourth lens, a fifth lens, a sixth lens, and a seventh lens,
the third lens has a positive power,
the fourth lens has a negative power,
the fifth lens has a positive power, and
the sixth lens has a negative power.

8. The imaging optical system according to claim 7, wherein,
when an Abbe number of the fifth lens is v5, and an Abbe number of the sixth lens is v6, the following conditional expressions are satisfied:
$$50. < v 5 ; \qquad ( 9 )$$
$$v 6 < 30. . \qquad ( 10 )$$

9. The imaging optical system according to claim 7, wherein the third lens is made of resin, and
the fifth lens is made of glass.

10. The imaging optical system according to claim 7, wherein
the third lens is made of glass, and
the fifth lens is made of resin.

11. The imaging optical system according to claim 2, wherein,
when a curvature radius of the lens surface of the first lens on the object side is R11, and a curvature radius of a lens surface of the first lens on the image side is R12, the following conditional expression is satisfied:
$$1.1 < ( R 11 + R 12 ) / ( R 11 - R12 ) < 2. . \qquad ( 4 )$$

12. The imaging optical system according to claim 11, wherein,
when a focal length of the entire lens system is f0, and the curvature radius of the lens surface of the first lens on the object side is R11, the following conditional expression is satisfied:
$$2. < R 11 / f 0 < 9. . \qquad ( 5 )$$

13. The imaging optical system according to claim 12, wherein,
when the focal length of the entire lens system is f0, and the curvature radius of the lens surface of the first lens on the image side is R12, the following conditional expression is satisfied:
$$0.5 < R 12 / f 0 < 3. . \qquad ( 6 )$$

14. The imaging optical system according to claim 13, wherein
the front group includes, in order from the object side to the image side, the first lens and a second lens, and,
when the focal length of the entire lens system is f0, a curvature radius of a lens surface of the second lens on the object side is R21, and a curvature radius of a lens surface of the second lens on the image side is R22, the following conditional expressions are satisfied:
$$- 6. 00 < R 21 / f 0 < - 1.5 \qquad ( 7 )$$
$$- 6. < R 22 / f 0 < - 1.5 . \qquad ( 8 )$$

15. The imaging optical system according to claim 14, wherein
the front group includes, in order from the object side to the image side, the first lens and the second lens,
the rear group includes, in order from the object side to the image side, a third lens, a fourth lens, a fifth lens, a sixth lens, and a seventh lens,
the third lens has a positive power,
the fourth lens has a negative power,
the fifth lens has a positive power, and
the sixth lens has a negative power.

16. The imaging optical system according to claim 15, wherein,
when an Abbe number of the fifth lens is v5, and an Abbe number of the sixth lens is v6, the following conditional expressions are satisfied:
$$50. < v 5 ; \qquad ( 9 )$$
$$v 6 < 30. ( 10 ) . \qquad ( 10 )$$

17. The imaging optical system according to claim 15, wherein
the third lens is made of resin, and
the fifth lens is made of glass.

18. The imaging optical system according to claim 15, wherein
the third lens is made of glass, and
the fifth lens is made of resin.

19. The imaging optical system according to claim 16, wherein
the third lens is made of resin, and
the fifth lens is made of glass.

20. The imaging optical system according to claim 16, wherein
the third lens is made of glass, and
the fifth lens is made of resin.
